(19) United States
(12) Patent Application Publication
(10) Pub. No.: US 2024/0204307 A1
(43) Pub. Date: Jun. 20, 2024

(54) EXTERIOR MATERIAL FOR POWER STORAGE DEVICE, MANUFACTURING METHOD THEREFOR, AND POWER STORAGE DEVICE

(71) Applicant: DAI NIPPON PRINTING CO., LTD., Tokyo (JP)

(72) Inventor: Ken MURASAWA, Tokyo (JP)

(73) Assignee: DAI NIPPON PRINTING CO., LTD., Tokyo (JP)

(21) Appl. No.: 18/285,351

(22) PCT Filed: Mar. 28, 2022
(86) PCT No.: PCT/JP2022/015034

§ 371 Date: Oct. 2, 2023

(30) Foreign Application Priority Data
Apr. 2, 2021 (JP) 2021-063785
Oct. 6, 2021 (JP) 2021-165119

(51) Int. Cl. H01M 50/129; H01M 50/121; H01M 50/133; H01M 50/134

(52) U.S. Cl. CPC H01M 50/129; H01M 50/121; H01M 50/133; H01M 50/134

(57) ABSTRACT

An exterior material for a power storage device, the exterior material being configured from a layered body that includes at least a substrate layer, a barrier layer, and a thermally fusible resin layer in this order, wherein in the thermally fusible resin layer, the molecular weight that is the peak value in a differential molecular weight distribution curve measured using high-temperature gel permeation chromatography is 150,000 or greater.

### TECHNICAL FIELD

The present disclosure relates to an exterior material for electrical storage devices, a method for manufacturing the exterior material for electrical storage devices, and an electrical storage device.

### BACKGROUND ART

Various types of electrical storage devices have been developed heretofore, and in every electrical storage device, an exterior material is an essential member for sealing electrical storage device elements such as an electrode and an electrolyte. Metallic exterior materials have been often used heretofore as exterior materials for electrical storage devices.

On the other hand, in recent years, electrical storage devices have been required to be diversified in shape and to be thinned and lightened with improvement of performance of electric cars, hybrid electric cars, personal computers, cameras, mobile phones and so on. However, metallic exterior material for electrical storage devices that have often been heretofore used have the disadvantage that it is difficult to keep up with diversification in shape, and there is a limit on weight reduction.

Thus, heretofore a film-shaped laminate with a base material layer, a barrier layer, an adhesive layer and a heat-sealable resin layer laminated in this order has been proposed as an exterior material for electrical storage devices which is easily processed into diversified shapes and is capable of achieving thickness reduction and weight reduction (see, for example, Patent Document 1).

In such an exterior material for electrical storage devices, generally, a concave portion is formed by cold molding, electrical storage device elements such as an electrode and an electrolytic solution are disposed in a space formed by the concave portion, and heat-sealable resin layers are heat-sealed to obtain an electrical storage device with electrical storage device elements stored in the exterior material for electrical storage devices.

### PRIOR ART DOCUMENT

### Patent Documents

Patent Document 1: Japanese Patent Laid-open Publication No. 2008-287971

Patent Document 2: Japanese Patent Laid-open Publication No. 2002-8616

### SUMMARY OF THE INVENTION

### Problems to be Solved by the Invention

In recent years, with high-speed and large-capacity data communication by smartphones, the amount of electricity consumed has increased, and an attempt has been made to increase the capacity of electrical storage devices. However, increasing the capacity of a battery involves an increase in container size and an increase in amount of reactive substances, and also leads to an increase in amount of gas generated if thermal runaway of an electrical storage device occurs (i.e., the temperature of the electrical storage device increases), thus raising the risk of explosion caused by an increase in internal pressure of the electrical storage device. In an electrical storage device (for example, a metal can battery) with a metallic exterior material, a safety valve is attached to secure safety at the time of generation of gas (see Patent Document 2).

However, in an electrical storage device with a laminated film-shaped exterior material, it is difficult to attach such a safety valve, and avoiding expansion of the electrical storage device which is caused by gas generated inside the electrical storage device having reached a high temperature is a challenge.

As a method for avoiding expansion of an electrical storage device which is caused by gas generated inside the electrical storage device having reached a high temperature, the melting point of a resin for forming a heat-sealable resin layer may be set low to facilitate opening at the position of the heat-sealable resin layer. There is also an advantage that the time required for a step of heat-sealing the heat-sealable resin layer can be shortened by lowering the melting point of the resin for forming the heat-sealable resin layer.

However, the electrical storage device is exposed to a high temperature (for example, about 100° C.) due to heating in a baking step in the manufacturing process of the electrical storage device, and therefore, if the melting point of the resin for forming the heat-sealable resin layer is lowered, there may be a problem that an exterior material for electrical storage devices is opened by heat and generated gas in the baking step involving a stable region (110° C. or lower) where the battery does not start thermal runaway.

Under these circumstances, a main object of the present disclosure is to provide an exterior material for electrical storage devices which includes a laminate including at least a base material layer, a barrier layer and a heat-sealable resin layer in this order, the electrical storage device being sealed by the exterior material for electrical storage devices until the electrical storage device reaches a high temperature (for example, about 100° C.).

### Means for Solving the Problem

The inventors of the present disclosure have extensively conducted studies for solving the above-described problems. Resultantly, the present inventors have found that an exterior material for electrical storage devices which includes a laminate including at least a base material layer, a barrier layer and a heat-sealable resin layer in this order, in which the heat-sealable resin layer has a molecular weight of 150,000 or more in terms of a peak value in a differential molecular weight distribution curve (differential molecular weight distribution curve with the molecular weight (logarithmic value) in the horizontal axis and the concentration fraction of a molecular weight: dw/d(Log(M)) in the vertical axis) obtained by high-temperature gel permeation chromatography measurement, can suitably seal an electrical storage device element until the electrical storage device reaches a high temperature (for example, about 100° C.).

The present disclosure has been completed by further conducting studies based on the above-mentioned findings. That is, the present disclosure provides an invention of an aspect as described below.

An exterior material for electrical storage devices which includes a laminate including at least a base material layer, a barrier layer and a heat-sealable resin layer in this order, the heat-sealable resin layer having a molecular weight of 150,000 or more in terms of a peak value in a differential molecular weight distribution curve obtained by high-temperature gel permeation chromatography measurement.

The present disclosure also provides an invention of an aspect described below. An exterior material for electrical storage devices which includes a laminate including at least a base material layer, a barrier layer and a heat-sealable resin layer in this order, in which a Martens hardness is 10.0 MPa or more as measured on the basis of an indentation method with a Vickers indenter pressed to a depth of 1 μm in a thickness direction from a surface of the exterior material for electrical storage devices on the heat-sealable resin layer side at a measurement temperature of 100° C.

### Advantages of the Invention

According to the present disclosure, it is possible to provide an exterior material for electrical storage devices which includes a laminate including at least a base material layer, a barrier layer and a heat-sealable resin layer in this order, in which an electrical storage device element can be suitably sealed until the electrical storage device reaches a high temperature (for example, about 100° C.). According to the present disclosure, it is also possible to provide a method for manufacturing an exterior material for electrical storage devices, and an electrical storage device.

### BRIEF DESCRIPTION OF THE DRAWINGS

FIG. 1 is a schematic diagram showing an example of a cross-sectional structure of an exterior material for electrical storage devices according to the present disclosure.

FIG. 2 is a schematic diagram showing an example of a cross-sectional structure of an exterior material for electrical storage devices according to the present disclosure.

FIG. 3 is a schematic diagram showing an example of a cross-sectional structure of an exterior material for electrical storage devices according to the present disclosure.

FIG. 4 is a schematic diagram for illustrating a method for housing an electrical storage device element in a packaging formed from an exterior material for electrical storage devices according to the present disclosure.

FIG. 5 is a schematic diagram for illustrating a method for measuring the heat-sealing strength.

FIG. 6 is a schematic diagram for illustrating a method for measuring the heat-sealing strength.

FIG. 7 is a schematic diagram for illustrating a method for measuring the softening point.

FIG. 8 is a schematic diagram of a differential molecular weight distribution curve.

### EMBODIMENTS OF THE INVENTION

An exterior material for electrical storage devices includes a laminate including at least a base material layer, a barrier layer and a heat-sealable resin layer in this order, the heat-sealable resin layer having a molecular weight of 150,000 or more in terms of a peak value in a differential molecular weight distribution curve obtained by high-temperature gel permeation chromatography measurement. The exterior material for electrical storage devices according to the present disclosure has such a configuration, so that an electrical storage device element can be suitably sealed until an electrical storage device reaches a high temperature (for example, about 100° C.).

The present disclosure also provides an exterior material for electrical storage devices which includes a laminate including at least a base material layer, a barrier layer and a heat-sealable resin layer in this order, in which a Martens hardness is 10.0 MPa or more as measured on the basis of an indentation method with a Vickers indenter pressed to a depth of 1 μm in a thickness direction from a surface of the exterior material for electrical storage devices on the heat-sealable resin layer side at a measurement temperature of 100° C. The exterior material for electrical storage devices can also suitably seal the electrical storage device element until the electrical storage device reaches a high temperature (for example, about 100° C.). In the exterior material for electrical storage devices, the heat-sealable resin layer is not required to have a molecular weight of 150,000 or more in terms of a peak value in a differential molecular weight distribution curve obtained by high-temperature gel permeation chromatography measurement, and the molecular weight is preferably 150,000 or more. The exterior material for electrical storage devices is not described in detail hereinbelow because except that the heat-sealable resin layer is not required to have a molecular weight of 150,000 or more in terms of a peak value in a differential molecular weight distribution curve obtained by high-temperature gel permeation chromatography measurement, the exterior material for electrical storage devices is the same as the foregoing exterior material for electrical storage devices according to the present disclosure in which the heat-sealable resin layer has a molecular weight of 150,000 or more in terms of a peak value in a differential molecular weight distribution curve obtained by high-temperature gel permeation chromatography measurement.

Hereinafter, the exterior material for electrical storage devices according to the present disclosure will be described in detail. In the present disclosure, a numerical range indicated by the term “A to B” means “A or more” and “B or less”. For example, the expression of “2 to 15 mm” means 2 mm or more and 15 mm or less.

In the exterior material for electrical storage devices, Machine Direction (MD) and Transverse Direction (TD) in the process for manufacturing thereof can be discriminated from each other for the barrier layer 3 described later. For example, when the barrier layer 3 includes a metal foil such as an aluminum alloy foil or a stainless steel foil, linear streaks called rolling indentations are formed on the surface of the metal foil in the rolling direction (RD) of the metal foil. Since the rolling indentations extend along the rolling direction, the rolling direction of the metal foil can be known by observing the surface of the metal foil. In the process for manufacturing of the laminate, the MD of the laminate and the RD of the metal foil normally coincides with each other, and therefore by observing the surface of the metal foil of the laminate to identify the rolling direction (RD) of the metal foil, the MD of the laminate can be identified. Since the TD of the laminate is perpendicular to the MD of the laminate, the TD of the laminate can be identified.

If the MD of the exterior material for electrical storage devices cannot be identified by the rolling indentations of the metal foil such as an aluminum alloy foil or a stainless steel foil, the MD can be identified by the following method. Examples of the method for identifying the MD of the exterior material for electrical storage devices include a method in which a cross-section of the heat-sealable resin layer of the exterior material for electrical storage devices is observed with an electron microscope to examine a sea-island structure. In the method, the direction parallel to a cross-section in which the average of the diameters of the island shapes in a direction perpendicular to the thickness direction of the heat-sealable resin layer is maximum can be determined as MD. Specifically, a cross-section in the length direction of the heat-sealable resin layer and cross-sections (a total of 10 cross-sections) at angular intervals of 10 degrees from a direction parallel to the cross-section in the length direction to a direction perpendicular to the cross-section in the length direction are observed with an electron microscope photograph to examine sea-island structures. Next, in each cross-section, the shape of each island is observed. For the shape of each island, the linear distance between the leftmost end in a direction perpendicular to the thickness direction of the heat-sealable resin layer and the rightmost end in the perpendicular direction is taken as a diameter y. In each cross-section, the average of the top 20 diameters y in descending order of the diameter y of the island shape is calculated. The direction parallel to a cross-section having the largest average of the diameters y of the island shapes is determined as MD.

### 1. Laminated Structure and Physical Property of Exterior Material for Electrical Storage Devices

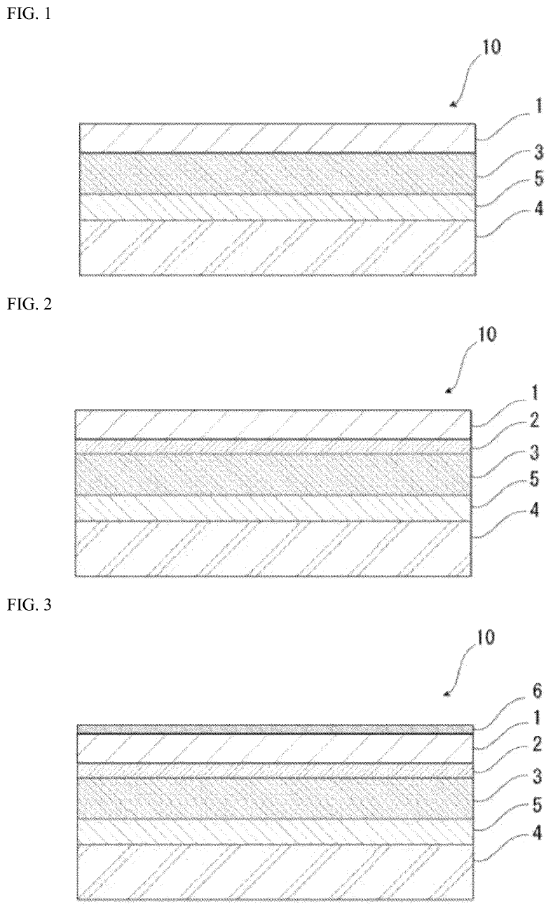

As shown in, for example, FIGS. 1 to 3, an exterior material 10 for electrical storage devices according to the present disclosure includes a laminate including at least a base material layer 1, a barrier layer 3 and a heat-sealable resin layer 4 in this order. In the exterior material 10 for electrical storage devices, the base material layer 1 is on the outermost layer side, and the heat-sealable resin layer 4 is an innermost layer. In construction of the electrical storage device using the exterior material 10 for electrical storage devices and electrical storage device elements, the electrical storage device elements are put in a space formed by heat-sealing the peripheral portions of heat-sealable resin layers 4 of the exterior material 10 for electrical storage devices which face each other. In the laminate forming the exterior material 10 for electrical storage devices according to the present disclosure, the heat-sealable resin layer 4 is on the inner side with respect to the barrier layer 3, and the base material layer 1 is on the outer side with respect to the barrier layer 3.

As shown in, for example, FIGS. 2 and 3, the exterior material 10 for electrical storage devices may have an adhesive agent layer 2 between the base material layer 1 and the barrier layer 3 if necessary for the purpose of, for example, improving bondability between these layers. As shown in FIGS. 2 and 3, an adhesive layer 5 may be present between the barrier layer 3 and the heat-sealable resin layer 4 if necessary for the purpose of, for example, improving bondability between these layers. As shown in FIG. 3, a surface coating layer 6 or the like may be provided on the outside of the base material layer 1 (on a side opposite to the heat-sealable resin layer 4 side) if necessary.

The thickness of the laminate forming the exterior material 10 for electrical storage devices is not particularly limited, and is, for example, about 190 μm or less, preferably about 180 μm or less, about 155 μm or less, or about 120 μm or less, from the viewpoint of cost reduction, energy density improvement, and the like. The thickness of the laminate forming the exterior material 10 for electrical storage devices is preferably about 35 μm or more, about 45 μm or more, or about 60 μm or more, from the viewpoint of maintaining the function of an exterior material for electrical storage devices, which is protection of an electrical storage device element. The laminate forming the exterior material 10 for electrical storage devices is preferably in the range of, for example, about 35 to 190 μm, about 35 to 180 μm, about 35 to 155 μm, about 35 to 120 μm, about 45 to 190 μm, about 45 to 180 μm, about 45 to 155 μm, about 45 to 120 μm, about 60 to 190 μm, about 60 to 180 μm, about 60 to 155 μm, and about 60 to 120 μm, particularly preferably about 60 to 155 μm.

In the exterior material 10 for electrical storage devices, the ratio of the total thickness of the base material layer 1, the adhesive agent layer 2 provided if necessary, the barrier layer 3, the adhesive layer 5 provided if necessary, the heat-sealable resin layer 4, and the surface coating layer 6 provided if necessary to the thickness (total thickness) of the laminate forming the exterior material 10 for electrical storage devices is preferably 90% or more, more preferably 95% or more, still more preferably 98% or more. As a specific example, when the exterior material 10 for electrical storage devices according to the present disclosure includes the base material layer 1, the adhesive agent layer 2, the barrier layer 3, the adhesive layer 5 and the heat-sealable resin layer 4, the ratio of the total thickness of these layers to the thickness (total thickness) of the laminate forming the exterior material 10 for electrical storage devices is preferably 90% or more, more preferably 95% or more, still more preferably 98% or more.

From the viewpoint of more suitably exhibiting the effect of the invention of the present disclosure, the heat-sealing strength of the exterior material for electrical storage devices according to the present disclosure is preferably about 50 N/15 mm or more, more preferably about 60 N/15 mm or more, still more preferably about 70 N/15 mm or more when the measurement temperature is 100° C. in measurement of the heat-sealing strength as described later. From the same viewpoint, the heat-sealing strength is preferably about 100 N/15 mm or less, more preferably about 90 N/15 mm or less. The heat-sealing strength is preferably in the range of about 50 to 100 N/15 mm, about 50 to 90 N/15 mm, about 60 to 100 N/15 mm, about 60 to 90 N/15 mm, about 70 to 100 N/15 mm, or about 70 to 90 N/15 mm.

From the viewpoint of more suitably exhibiting the effect of the invention of the present disclosure, the heat-sealing strength of the exterior material for electrical storage devices according to the present disclosure is preferably about 35 N/15 mm or more, more preferably about 40 N/15 mm or more, still more preferably about 50 N/15 mm or more when the measurement temperature is 110° C. in measurement of the heat-sealing strength as described later. From the same viewpoint, the heat-sealing strength is preferably about 80 N/15 mm or more, more preferably about 75 N/15 mm or more, still more preferably about 70 N/15 mm or more. The heat-sealing strength is preferably in the range of about 35 to 80 N/15 mm, about 35 to 75 N/15 mm, about 35 to 70 N/15 mm, about 40 to 80 N/15 mm, about 40 to 75 N/15 mm, about 40 to 70 N/15 mm, about 50 to 80 N/15 mm, about 50 to 75 N/15 mm, or about 50 to 70 N/15 mm.

From the viewpoint of more suitably exhibiting the effect of the invention of the present disclosure, the heat-sealing strength of the exterior material for electrical storage devices according to the present disclosure is preferably about 2 N/15 mm or more, more preferably about 5 N/15 mm or more, still more preferably about 10 N/15 mm or more when the measurement temperature is 120° C. in measurement of the heat-sealing strength as described later. From the same viewpoint, the heat-sealing strength is preferably about 70 N/15 mm or less, more preferably about 60 N/15 mm or less. The heat-sealing strength is preferably in the range of about 2 to 70 N/15 mm, about 2 to 60 N/15 mm, about 5 to 70 N/15 mm, about 5 to 60 N/15 mm, about 10 to 70 N/15 mm, or about 10 to 60 N/15 mm.

The method for measuring the heat-sealing strength is as follows.

### Measurement of Heat-Sealing Strength

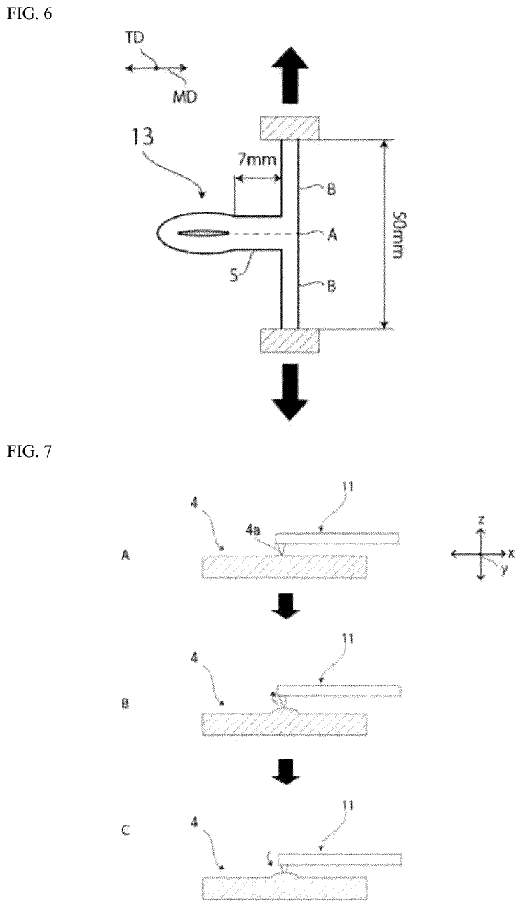

As specified in JIS K 7127: 1999, the heat-sealing strength is measured at each of measurement temperatures (sample temperatures) (for example, 25° C., 100° C., 110° C. and 120° C. A test piece is prepared by cutting the exterior material for electrical storage devices into a strip shape having a width of 15 mm in a transverse direction. Specifically, first, the exterior material for electrical storage devices is cut into a size of 60 mm (transverse direction)×200 mm (machine direction) as shown in FIG. 5 (FIG. 5a). Next, the exterior material for electrical storage devices is double-folded in the machine direction at the position of the fold P (intermediate in the machine direction) in such a manner that the heat-sealable resin layers face each other (FIG. 5b). The heat-sealable resin layers are heat-sealed on the inner side in the machine direction by about 10 mm from the fold P under the conditions of a seal width of 7 mm, a temperature of 190° C., a surface pressure of 1.0 MPa and 3 seconds (FIG. 5c). In FIG. 5c, the shaded portion S is a heat-sealed portion. Next, a test sample is obtained by cutting the sample in the machine direction (cutting the sample at the position of the two-dot chain line in FIG. 5d) in such a manner that the width in the transverse direction is 15 mm (FIG. 5e). Next, the measurement sample 13 is allowed to stand at each measurement temperature for 2 minutes, and the heat-sealable resin layer at the heat-sealed part is peeled at a speed of 300 mm/min with a tensile tester (e.g. AG-Xplus (trade name) manufactured by Shimadzu Corporation) in an environment at each measurement temperature (FIG. 6). The maximum strength during the peeling is taken as heat-sealing strength (N/15 mm). The chuck-to-chuck distance is 50 mm. Specific examples are shown in Examples.

From the viewpoint of more suitably exhibiting the effect of the invention of the present disclosure, the Martens hardness is preferably 10.0 MPa or more, more preferably 11.0 MPa or more, still more preferably 12.0 MPa as measured on the basis of an indentation method with a Vickers indenter pressed to a depth of 1 μm in a thickness direction from a surface of the exterior material 10 for electrical storage devices on the heat-sealable resin layer 4 side at a measurement temperature (sample temperature) of 100° C. From the same viewpoint, the Martens hardness is preferably 25.0 MPa or less, more preferably 20.0 MPa or less. The Martens hardness is preferably in the range of about 10.0 to 25.0 MPa, about 10.0 to 20.0 MPa, about 11.0 to 25.0 MPa, about 11.0 to 20.0 MPa, about 12.0 to 25.0 MPa, or about 12.0 to 20.0 MPa. When the Martens hardness at 100° C. is in the above-described range, opening at an unexpected temperature can be prevented as the heat-sealable resin layer hardly moves even if the internal pressure starts to rise due to generation of gas from the inside of the electrical storage device, and opening of the exterior material for electrical storage devices by, for example, gas generated by heating in a baking step in the manufacturing process of the electrical storage device can be further more suitably prevented. The method for measuring the Martens hardness is as follows.

### Measurement of Martens Hardness

The Martens hardness is measured on the basis of an indentation method with a Vickers indenter pressed to a depth of 1 μm in a thickness direction from a surface of the exterior material for electrical storage devices on the heat-sealable resin layer side at a measurement temperature (sample temperature) of 100° C. The measurement conditions are as follows. The Martens hardness is calculated from a load-displacement curve obtained by pressing the Vickers indenter. As a measurement value, an average of values for 10 portions of the surface on the heat-sealable resin layer side is adopted. The Martens hardness is determined by calculating the surface area A (mm²) of the Vickers indenter at the maximum depth of indentation, and dividing the maximum load F (N) by the surface area A (mm²) (F/A). As a measuring apparatus, for example, PICODENTOR HM-500 manufactured by FISCHER INSTRUMENTS K.K. is used. For example, to one surface of slide glass (76 mm×26 mm×1 mm) to which a double-sided pressure sensitive adhesive tape is attached, the exterior material for electrical storage devices is bonded in such a manner that the heat-sealable resin layer is on a side opposite to the slide glass, thereby obtaining a measurement sample. Next, a heating stage is installed on an ultra-microhardness tester equipped with a Vickers indenter, and the sample is heated for 5 minutes with the stage temperature set to 110° C. Next, the hardness of a surface of the measurement sample on the heat-sealable resin layer side is measured.

### Measurement Conditions

Indenter: Vickers indenter (facing angle of tip end part of quadrangular pyramid: 136°)
Measurement temperature (sample temperature): 100° C.
Stage temperature: 110° C.
Speed: 1.000 μm/10 sec
Measurement depth: 1.0 μm
Retention time: 5 sec
Speed of recovery from pressed state: 1.000 μm/10 sec

### 2. Layers Forming Exterior Material for Electrical Storage Devices

### Base Material Layer 1

In the present disclosure, the base material layer 1 is a layer provided for the purpose of, for example, exhibiting a function as a base material of the exterior material for electrical storage devices. The base material layer 1 is located on the outer layer side of the exterior material for electrical storage devices.

The material that forms the base material layer 1 is not particularly limited as long as it has a function as a base material, i.e. at least insulation quality. The base material layer 1 can be formed using, for example, a resin, and the resin may contain additives described later.

When the base material layer 1 is formed of a resin, the base material layer 1 may be, for example, a resin film formed of a resin, or may be formed by applying a resin. The resin film may be an unstretched film or a stretched film. Examples of the stretched film include uniaxially stretched films and biaxially stretched films, and biaxially stretched films are preferable. Examples of the stretching method for forming a biaxially stretched film include a sequential biaxial stretching method, an inflation method, and a simultaneous biaxial stretching method. Examples of the method for applying a resin include a roll coating method, a gravure coating method and an extrusion coating method.

Examples of the resin that forms the base material layer 1 include resins such as polyester, polyamide, polyolefin, epoxy resin, acrylic resin, fluororesin, polyurethane, silicone resin and phenol resin, and modified products of these resins. The resin that forms the base material layer 1 may be a copolymer of these resins or a modified product of the copolymer. Further, a mixture of these resins may be used.

Of these resins, polyester and polyamide are preferable as resins that form the base material layer 1.

Specific examples of the polyester include polyethylene terephthalate, polybutylene terephthalate, polyethylene naphthalate, polybutylene naphthalate, polyethylene isophthalate, and copolyesters. Examples of the copolyester include copolyesters having ethylene terephthalate as a main repeating unit. Specific examples thereof include copolymer polyesters that are polymerized with ethylene isophthalate and include ethylene terephthalate as a main repeating unit (hereinafter, abbreviated as follows after polyethylene(terephthalate/isophthalate)), polyethylene(terephthalate/adipate), polyethylene(terephthalate/sodium sulfoisophthalate), polyethylene(terephthalate/sodium isophthalate), polyethylene (terephthalate/phenyl-dicarboxylate) and polyethylene(terephthalate/decane dicarboxylate). These polyesters may be used alone, or may be used in combination of two or more thereof.

Specific examples of the polyamide include polyamides such as aliphatic polyamides such as nylon 6, nylon 66, nylon 610, nylon 12, nylon 46, and copolymers of nylon 6 and nylon 66; hexamethylenediamine-isophthalic acid-terephthalic acid copolymerization polyamides containing a structural unit derived from terephthalic acid and/or isophthalic acid, such as nylon 6I, nylon 6T, nylon 6IT and nylon 616T (I denotes isophthalic acid and T denotes terephthalic acid), and polyamides containing aromatics, such as polyamide MXD6 (polymethaxylylene adipamide); alicyclic polyamides such as polyamide PACM6 (polybis(4-aminocyclohexyl)methaneadipamide; polyamides copolymerized with a lactam component or an isocyanate component such as 4,4-diphenylmethane-diisocyanate, and polyester amide copolymers and polyether ester amide copolymers as copolymers of a copolymerization polyamide and a polyester or a polyalkylene ether glycol; and copolymers thereof. These polyamides may be used alone, or may be used in combination of two or more thereof.

The base material layer 1 contains preferably at least one of a polyester film, a polyamide film and a polyolefin film, preferably at least one of a stretched polyester film, a stretched polyamide film and a stretched polyolefin film, still more preferably at least one of a stretched polyethylene terephthalate film, a stretched polybutylene terephthalate film, a stretched nylon film and a stretched polypropylene film, even more preferably at least one of a biaxially stretched polyethylene terephthalate film, a biaxially stretched polybutylene terephthalate film, a biaxially stretched nylon film, and a biaxially stretched polypropylene film.

The base material layer 1 may be a single layer, or may include two or more layers. When the base material layer 1 includes two or more layers, the base material layer 1 may be a laminate obtained by laminating resin films with an adhesive agent or the like, or a resin film laminate obtained by co-extruding resins to form two or more layers. The resin film laminate obtained by co-extruding resins to form two or more layers may be used as the base material layer 1 in an unstretched state, or may be uniaxially stretched or biaxially stretched and used as the base material layer 1.

Specific examples of the resin film laminate with two or more layers in the base material layer 1 include laminates of a polyester film and a nylon film, nylon film laminates with two or more layers, and polyester film laminates with two or more layers. Laminates of a stretched nylon film and a stretched polyester film, stretched nylon film laminates with two or more layers, and stretched polyester film laminates with two or more layers are preferable. For example, when the base material layer 1 is a resin film laminate with two layers, the base material layer 1 is preferably a laminate of a polyester resin film and a polyester resin film, a laminate of a polyamide resin film and a polyamide resin film, or a laminate of a polyester resin film and a polyamide resin film, more preferably a laminate of a polyethylene terephthalate film and a polyethylene terephthalate film, a laminate of a nylon film and a nylon film, or a laminate of a polyethylene terephthalate film and a nylon film. Since the polyester resin is hardly discolored even in the case where for example, an electrolytic solution is deposited on the surface, it is preferable that the polyester resin film is located at the outermost layer of the base material layer 1 when the base material layer 1 is a resin film laminate with two or more layers.

When the base material layer 1 is a resin film laminate with two or more layers, the two or more resin films may be laminated with an adhesive agent interposed therebetween. Specific examples of the preferred adhesive agent include the same adhesive agents as those exemplified for the adhesive agent layer 2 described later. The method for laminating a resin film having two or more layers is not particularly limited, and a known method can be employed. Examples thereof include a dry lamination method, a sand lamination method, an extrusion lamination method and a thermal lamination method, and a dry lamination method is preferable. When the resin film is laminated by a dry lamination method, it is preferable to use a polyurethane adhesive agent as the adhesive agent. Here, the thickness of the adhesive agent is, for example, about 2 to 5 μm. In addition, the lamination may be performed with an anchor coat layer formed on the resin film. Examples of the anchor coat layer include the same adhesive agents as those exemplified for the adhesive agent layer 2 described later. Here, the thickness of the anchor coat layer is, for example, about 0.01 to 1.0 μm.

Additives such as a slipping agent, a flame retardant, an antiblocking agent, an antioxidant, a light stabilizer, a tackifier and an antistatic agent may be present on at least one of the surface of the base material layer 1 and/or inside the base material layer 1. The additives may be used alone, or may be used in combination of two or more thereof.

In the present disclosure, it is preferable that a slipping agent is present on the surface of the base material layer 1 from the viewpoint of enhancing the moldability of the exterior material for electrical storage devices. The slipping agent is not particularly limited, and is preferably an amide-based slipping agent. Specific examples of the amide-based slipping agent include saturated fatty acid amides, unsaturated fatty acid amides, substituted amides, methylol amides, saturated fatty acid bisamides, unsaturated fatty acid bisamides, fatty acid ester amides, and aromatic bisamides. Specific examples of the saturated fatty acid amide include lauric acid amide, palmitic acid amide, stearic acid amide, behenic acid amide, and hydroxystearic acid amide. Specific examples of unsaturated fatty acid amide include oleic acid amide and erucic acid amide. Specific examples of the substituted amide include N-oleylpalmitic acid amide, N-stearyl stearic acid amide, N-stearyl oleic acid amide, N-oleyl stearic acid amide, and N-stearyl erucic acid amide. Specific examples of the methylolamide include methylolstearic acid amide. Specific examples of the saturated fatty acid bisamide include methylenebisstearic acid amide, ethylenebiscapric acid amide, ethylenebislauric acid amide, ethylenebisstearic acid amide, ethylenebishydroxystearic acid amide, ethylenebisbehenic acid amide, hexamethylenebisstearic acid amide, hexamethylenehydroxystearic acid amide, N,N′-distearyl adipic acid amide, and N,N′-distearyl sebacic acid amide. Specific examples of the unsaturated fatty acid bisamide include ethylenebisoleic acid amide, ethylenebiserucic acid amide, hexamethylenebisoleic acid amide, N,N [symbol] dioleyladipic acid amide, and N,N [symbol] dioleylsebacic acid amide. Specific examples of the fatty acid ester amide include stearoamideethyl stearate. Specific examples of the aromatic bisamide include m-xylylenebisstearic acid amide, m-xylylenebishydroxystearic acid amide, and N,N [symbol] distearylisophthalic acid amide. The slipping agents may be used alone, or may be used in combination of two or more thereof.

When the slipping agent is present on the surface of the base material layer 1, the amount of the slipping agent present is not particularly limited, and is preferably about 3 mg/m² or more, more preferably about 4 to 15 mg/m², still more preferably about 5 to 14 mg/m².

The slipping agent present on the surface of the base material layer 1 may be one obtained by exuding the slipping agent contained in the resin forming the base material layer 1, or one obtained by applying the slipping agent to the surface of the base material layer 1.

The thickness of the base material layer 1 is not particularly limited as long as a function as a base material is performed, and the thickness of the base material layer 1 is, for example, about 3 to 50 μm, preferably about 10 to 35 μm. When the base material layer 1 is a resin film laminate with two or more layers, the thickness of the resin film forming each layer is preferably about 2 to 25 μm.

### Adhesive Agent Layer 2

In the exterior material for electrical storage devices of the present disclosure, the adhesive agent layer 2 is a layer provided between the base material layer 1 and the barrier layer 3 if necessary for the purpose of enhancing bondability between these layers.

The adhesive agent layer 2 is formed from an adhesive agent capable of bonding the base material layer 1 and the barrier layer 3. The adhesive agent used for forming the adhesive agent layer 2 is not limited, and may be any of a chemical reaction type, a solvent volatilization type, a heat melting type, a heat pressing type, and the like. The adhesive agent may be a two-liquid curable adhesive agent (two-liquid adhesive agent), a one-liquid curable adhesive agent (one-liquid adhesive agent), or a resin that does not involve curing reaction. The adhesive agent layer 2 may be a single layer or a multi-layer.

Specific examples of the adhesive component contained in the adhesive agent include polyester such as polyethylene terephthalate, polybutylene terephthalate, polyethylene naphthalate, polybutylene naphthalate, polyethylene isophthalate and copolyester; polyether; polyurethane; epoxy resins; phenol resins; polyamides such as nylon 6, nylon 66, nylon 12 and copolymerized polyamide; polyolefin-based resins such as polyolefins, cyclic polyolefins, acid-modified polyolefins and acid-modified cyclic polyolefins; cellulose; (meth)acrylic resins; polyimide; polycarbonate; amino resins such as urea resins and melamine resins; rubbers such as chloroprene rubber, nitrile rubber and styrene-butadiene rubber; and silicone resins. These adhesive components may be used alone, or may be used in combination of two or more thereof. Of these adhesive components, polyurethane-based adhesive agents are preferable. In addition, the adhesive strength of these resins used as adhesive components can be increased by using an appropriate curing agent in combination. As the curing agent, appropriate one is selected from polyisocyanate, a polyfunctional epoxy resin, an oxazoline group-containing polymer, a polyamine resin, an acid anhydride and the like according to the functional group of the adhesive component.

Examples of the polyurethane adhesive agent include polyurethane adhesive agents containing a first component containing a polyol compound and a second component containing an isocyanate compound. The polyurethane adhesive agent is preferably a two-liquid curable polyurethane adhesive agent having polyol such as polyester polyol, polyether polyol or acrylic polyol as a first component, and aromatic or aliphatic polyisocyanate as a second component. Examples of the polyurethane adhesive agent include polyurethane adhesive agents containing an isocyanate compound and a polyurethane compound obtained by reacting a polyol compound with an isocyanate compound in advance. Examples of the polyurethane adhesive agent include polyurethane adhesive agents containing a polyol compound and a polyurethane compound obtained by reacting a polyol compound with an isocyanate compound in advance. Examples of the polyurethane adhesive agent include polyurethane adhesive agents obtained by reacting a polyol compound with an isocyanate compound to form a polyurethane compound in advance, and reacting the polyurethane compound with moisture in the air or the like. It is preferable that polyester polyol having a hydroxyl group in the side chain in addition to a hydroxyl group at the end of the repeating unit is used as the polyol compound. Examples of the second component include aliphatic, alicyclic, aromatic and araliphatic isocyanate-based compounds. Examples of the isocyanate-based compound include hexamethylene diisocyanate (HDI), xylylene diisocyanate (XDI), isophorone diisocyanate (IPDI), hydrogenated XDI (H6XDI), hydrogenated MDI (H12MDI), tolylene diisocyanate (TDI), diphenylmethane diisocyanate (MDI) and naphthalene diisocyanate (NDI). Examples of the isocyanate-based compound also include polyfunctional isocyanate-modified products of one or more of these diisocyanates can be mentioned. It is also possible to use a multimer (e.g. a trimer) as the polyisocyanate compound. Examples of the multimer include adducts, biurets, and nurates. Since the adhesive agent layer 2 is formed of a polyurethane adhesive agent, excellent electrolytic solution resistance is imparted to the exterior material for electrical storage devices, so that peeling of the base material layer 1 is suppressed even if the electrolytic solution is deposited on the side surface.

Other components may be added to the adhesive agent layer 2 as long as bondability is not inhibited, and the adhesive agent layer 2 may contain a colorant, a thermoplastic elastomer, a tackifier, a filler, and the like. When the adhesive agent layer 2 contains a colorant, the exterior material for electrical storage devices can be colored. As the colorant, known colorants such as pigments and dyes can be used. The colorants may be used alone, or may be used in combination of two or more thereof.

The type of pigment is not particularly limited as long as the bondability of the adhesive agent layer 2 is not impaired. Examples of the organic pigment include azo-based pigments, phthalocyanine-based pigments, quinacridone-based pigments, anthraquinone-based pigments, dioxazine-based pigments, indigothioindigo-based pigments, perinone-perylene-based pigments, isoindolenine-based pigments and benzimidazolone-based pigments. Examples of the inorganic pigment include carbon black-based pigments, titanium oxide-based pigments, cadmium-based pigments, lead-based pigments, chromium-based pigments and iron-based pigments, and also fine powder of mica (mica) and fish scale foil.

Of the colorants, carbon black is preferable for the purpose of, for example, blackening the appearance of the exterior material for electrical storage devices.

The average particle diameter of the pigment is not particularly limited, and is, for example, about 0.05 to 5 μm, preferably about 0.08 to 2 μm. The average particle diameter of the pigment is a median diameter measured by a laser diffraction/scattering particle diameter distribution measuring apparatus.

The content of the pigment in the adhesive agent layer 2 is not particularly limited as long as the exterior material for electrical storage devices is colored, and the content is, for example, about 5 to 60 mass %, preferably 10 to 40 mass %.

The thickness of the adhesive agent layer 2 is not particularly limited as long as the base material layer 1 and the barrier layer 3 can be bonded to each other, and the thickness is, for example, about 1 μm or more, or about 2 μm or more. The thickness of the adhesive agent layer 2 is, for example, about 10 μm or less, or about 5 μm or less. The thickness of the adhesive agent layer 2 is preferably in the range of about 1 to 10 um, about 1 to 5 μm, about 2 to 10 μm, or about 2 to 5 μm.

### Colored Layer

The colored layer is a layer provided between the base material layer 1 and the barrier layer 3 if necessary (not shown). When the adhesive agent layer 2 is present, the colored layer may be provided between the base material layer 1 and the adhesive agent layer 2 or between the adhesive agent layer 2 and the barrier layer 3. The colored layer may be provided outside the base material layer 1. By providing the colored layer, the exterior material for electrical storage devices can be colored.

The colored layer can be formed by, for example, applying an ink containing a colorant to the surface of the base material layer 1, or the surface of the barrier layer 3. As the colorant, known colorants such as pigments and dyes can be used. The colorants may be used alone, or may be used in combination of two or more thereof.

Specific examples of the colorant contained in the colored layer include the same colorants as those exemplified in the section [Adhesive Agent Layer 2].

### Barrier Layer 3

In the exterior material for electrical storage devices, the barrier layer 3 is a layer which suppresses at least ingress of moisture.

Examples of the barrier layer 3 include metal foils, deposited films and resin layers having a barrier property. Examples of the deposited film include metal deposited films, inorganic oxide deposited films and carbon-containing inorganic oxide deposited films, and examples of the resin layer include those of polyvinylidene chloride, fluorine-containing resins such as polymers containing chlorotrifluoroethylene (CTFE) as a main component, polymers containing tetrafluoroethylene (TFE) as a main component, polymers having a fluoroalkyl group, and polymers containing a fluoroalkyl unit as a main component, and ethylene vinyl alcohol copolymers. Examples of the barrier layer 3 include resin films provided with at least one of these deposited films and resin layers. A plurality of barrier layers 3 may be provided. Preferably, the barrier layer 3 contains a layer formed of a metal material. Specific examples of the metal material forming the barrier layer 3 include aluminum alloys, stainless steel, titanium steel and steel sheets. When the metal material is used as a metal foil, it is preferable that the metal material includes at least one of an aluminum alloy foil and a stainless steel foil.

The aluminum alloy is more preferably a soft aluminum alloy foil formed of, for example, an annealed aluminum alloy from the viewpoint of improving the moldability of the exterior material for electrical storage devices, and is preferably an aluminum alloy foil containing iron from the viewpoint of further improving the moldability. In the aluminum alloy foil containing iron (100 mass %), the content of iron is preferably 0.1 to 9.0 mass %, more preferably 0.5 to 2.0 mass %. When the content of iron is 0.1 mass % or more, it is possible to obtain an exterior material for electrical storage devices which has more excellent moldability. When the content of iron is 9.0 mass % or less, it is possible to obtain an exterior material for electrical storage devices which is more excellent in flexibility. Examples of the soft aluminum alloy foil include aluminum alloy foils having a composition specified in JIS H4160: 1994 A8021H-O, JIS H4160: 1994 A8079H-O, JIS H4000: 2014 A8021P-O, or JIS H4000: 2014 A8079P-O. If necessary, silicon, magnesium, copper, manganese or the like may be added. Softening can be performed by annealing or the like.

Examples of the stainless steel foil include austenitic stainless steel foils, ferritic stainless steel foils, austenitic/ferritic stainless steel foils, martensitic stainless steel foils and precipitation-hardened stainless steel foils. From the viewpoint of providing an exterior material for electrical storage devices which is further excellent in moldability, it is preferable that the stainless steel foil is formed of austenitic stainless steel.

Specific examples of the austenite-based stainless steel foil include SUS 304 stainless steel, SUS 301 stainless steel and SUS 316L stainless steel, and of these, SUS 304 stainless steel is especially preferable.

When the barrier layer 3 is a metal foil, the barrier layer 3 may perform a function as a barrier layer suppressing at least ingress of moisture, and has a thickness of, for example, about 9 to 200 μm. The thickness of the barrier layer 3 is preferably about 85 μm or less, more preferably about 50 μm or less, still more preferably about 40 μm or less, particularly preferably about 35 μm or less. The thickness of the barrier layer 3 is preferably about 10 μm or more, more preferably about 20 μm or more, still more preferably about 25 μm or more. The total thickness of the barrier layer 3 is preferably in the range of about 10 to 85 μm, about 10 to 50 μm, about 10 to 40 μm, about 10 to 35 μm, about 20 to 85 μm, about 20 to 50 μm, about 20 to 40 μm, about 20 to 35 μm, about 25 to 85 μm, about 25 to 50 μm, about 25 to 40 μm, or about 25 to 35 μm. When the barrier layer 3 is formed of an aluminum alloy foil, the thickness thereof is especially preferably in above-described range. In particular, when the barrier layer 3 includes a stainless steel foil, the thickness of the stainless steel foil is preferably about 60 μm or less, more preferably about 50 μm or less, still more preferably about 40 μm or less, even more preferably about 30 μm or less, particularly preferably about 25 μm or less. The thickness of the stainless steel foil is preferably about 10 μm or more, more preferably about 15 μm or more. The thickness of the stainless steel foil is preferably in the range of about 10 to 60 μm, about 10 to 50 μm, about 10 to 40 μm, about 10 to 30 μm, about 10 to 25 μm, about 15 to 60 μm, about 15 to 50 μm, about 15 to 40 μm, about 15 to 30 μm, or about 15 to 25 μm.

When the barrier layer 3 is a metal foil, it is preferable that a corrosion-resistant film is provided at least on a surface on a side opposite to the base material layer for preventing dissolution and corrosion. The barrier layer 3 may include a corrosion-resistant film on each of both surfaces. Here, the corrosion-resistant film refers to a thin film obtained by subjecting the surface of the barrier layer to, for example, hydrothermal denaturation treatment such as boehmite treatment, chemical conversion treatment, anodization treatment, plating treatment with nickel, chromium or the like, or corrosion prevention treatment by applying a coating agent to impart corrosion resistance (e.g. acid resistance and alkali resistance) to the barrier layer. Specifically, the corrosion-resistant film means a film which improves the acid resistance of the barrier layer (acid-resistant film), a film which improves the alkali resistance of the barrier layer (alkali-resistant film), or the like. One of treatments for forming the corrosion-resistant film may be performed, or two or more thereof may be performed in combination. In addition, not only one layer but also multiple layers can be formed. Further, of these treatments, the hydrothermal denaturation treatment and the anodization treatment are treatments in which the surface of the metal foil is dissolved with a treatment agent to form a metal compound excellent in corrosion resistance. The definition of the chemical conversion treatment may include these treatments. When the barrier layer 3 is provided with the corrosion-resistant film, the barrier layer 3 is regarded as including the corrosion-resistant film.

The corrosion-resistant film exhibits the effects of preventing delamination between the barrier layer (e.g. an aluminum alloy foil) and the base material layer during molding of the exterior material for electrical storage devices; preventing dissolution and corrosion of the surface of the barrier layer, particularly dissolution and corrosion of aluminum oxide present on the surface of the barrier layer when the barrier layer is an aluminum alloy foil, by hydrogen fluoride generated by reaction of an electrolyte with moisture; improving the bondability (wettability) of the surface of the barrier layer; preventing delamination between the base material layer and the barrier layer during heat-sealing; and preventing delamination between the base material layer and the barrier layer during molding.

Various corrosion-resistant films formed by chemical conversion treatment are known, and examples thereof include mainly corrosion-resistant films containing at least one of a phosphate, a chromate, a fluoride, a triazine thiol compound, and a rare earth oxide. Examples of the chemical conversion treatment using a phosphate or a chromate include chromic acid chromate treatment, phosphoric acid chromate treatment, phosphoric acid-chromate treatment and chromate treatment, and examples of the chromium compound used in these treatments include chromium nitrate, chromium fluoride, chromium sulfate, chromium acetate, chromium oxalate, chromium biphosphate, acetylacetate chromate, chromium chloride and chromium potassium sulfate. Examples of the phosphorus compound used in these treatments include sodium phosphate, potassium phosphate, ammonium phosphate and polyphosphoric acid. Examples of the chromate treatment include etching chromate treatment, electrolytic chromate treatment and coating-type chromate treatment, and coating-type chromate treatment is preferable. This coating-type chromate treatment is treatment in which at least a surface of the barrier layer (e.g. an aluminum alloy foil) on the inner layer side is first degreased by a well-known treatment method such as an alkali immersion method, an electrolytic cleaning method, an acid cleaning method, an electrolytic acid cleaning method or an acid activation method, and a treatment solution containing a metal phosphate such as Cr (chromium) phosphate, Ti (titanium) phosphate, Zr (zirconium) phosphate or Zn (zinc) phosphate or a mixture of these metal salts as a main component, a treatment solution containing any of non-metal salts of phosphoric acid and a mixture of these non-metal salts as a main component, or a treatment solution formed of a mixture of any of these salts and a synthetic resin or the like is then applied to the degreased surface by a well-known coating method such as a roll coating method, a gravure printing method or an immersion method, and dried. As the treatment liquid, for example, various solvents such as water, an alcohol-based solvent, a hydrocarbon-based solvent, a ketone-based solvent, an ester-based solvent, and an ether-based solvent can be used, and water is preferable. Examples of the resin component used here include polymers such as phenol-based resins and acryl-based resins, and examples of the treatment include chromate treatment using an aminated phenol polymer having any of repeating units represented by the following General Formulae (1) to (4). In the aminated phenol polymer, the repeating units represented by the following General Formulae (1) to (4) may be contained alone, or may be contained in combination of two or more thereof. The acryl-based resin is preferably polyacrylic acid, an acrylic acid-methacrylic acid ester copolymer, an acrylic acid-maleic acid copolymer, an acrylic acid-styrene copolymer, or a derivative thereof such as a sodium salt, an ammonium salt or an amine salt thereof. In particular, a derivative of polyacrylic acid such as an ammonium salt, a sodium salt or an amine salt of polyacrylic acid is preferable. In the present disclosure, the polyacrylic acid means a polymer of acrylic acid. The acryl-based resin is also preferably a copolymer of acrylic acid and dicarboxylic acid or dicarboxylic anhydride, and is also preferably an ammonium salt, a sodium salt or an amine salt of a copolymer of acrylic acid and dicarboxylic acid or dicarboxylic anhydride. The acryl-based resins may be used alone, or may be used in combination of two or more thereof.

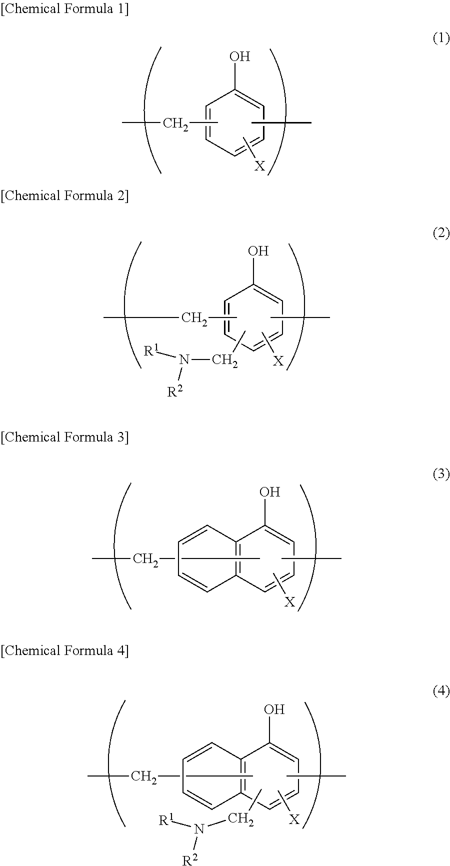

In General Formulae (1) to (4), X represents a hydrogen atom, a hydroxy group, an alkyl group, a hydroxyalkyl group, an allyl group, or a benzyl group. R¹ and R² are the same or different, and each represents a hydroxy group, an alkyl group, or a hydroxyalkyl group. In General Formulae (1) to (4), examples of the alkyl group represented by X, R¹ and R² include linear or branched alkyl groups with a carbon number of 1 to 4, such as a methyl group, an ethyl group, an n-propyl group, an isopropyl group, an n-butyl group, an isobutyl group, and a tert-butyl group. Examples of the hydroxyalkyl group represented by X, R¹ and R² include linear or branched alkyl groups with a carbon number of 1 to 4, which is substituted with one hydroxy group, such as a hydroxymethyl group, a 1-hydroxyethyl group, a 2-hydroxyethyl group, a 1-hydroxypropyl group, a 2-hydroxypropyl group, a 3-hydroxypropyl group, a 1-hydroxybutyl group, a 2-hydroxybutyl group, a 3-hydroxybutyl group, and a 4-hydroxybutyl group. In General Formulae (1) to (4), the alkyl group and the hydroxyalkyl group represented by X, R¹ and R² may be the same or different. In General Formulae (1) to (4), X is preferably a hydrogen atom, a hydroxy group or a hydroxyalkyl group. A number average molecular weight of the aminated phenol polymer having repeating units represented by General Formulae (1) to (4) is preferably about 500 to 1,000,000, and more preferably about 1,000 to 20,000, for example. The aminated phenol polymer is produced by, for example, performing polycondensation of a phenol compound or a naphthol compound with formaldehyde to prepare a polymer including repeating units represented by General Formula (1) or General Formula (3), and then introducing a functional group (—CH₂NR¹R²) into the obtained polymer using formaldehyde and an amine (R¹R²NH). The aminated phenol polymers are used alone, or used in combination of two or more thereof.

Other examples of the corrosion-resistant film include thin films formed by corrosion prevention treatment of coating type in which a coating agent containing at least one selected from the group consisting of a rare earth element oxide sol, an anionic polymer and a cationic polymer is applied. The coating agent may further contain phosphoric acid or a phosphate, and a crosslinker for crosslinking the polymer. In the rare earth element oxide sol, fine particles of a rare earth element oxide (e.g. particles having an average particle diameter of 100 nm or less) are dispersed in a liquid dispersion medium. Examples of the rare earth element oxide include cerium oxide, yttrium oxide, neodymium oxide and lanthanum oxide, and cerium oxide is preferable from the viewpoint of further improving adhesion. The rare earth element oxides contained in the corrosion-resistant film can be used alone, or used in combination of two or more thereof. As the liquid dispersion medium for the rare earth element oxide, for example, various solvents such as water, an alcohol-based solvent, a hydrocarbon-based solvent, a ketone-based solvent, an ester-based solvent, and an ether-based solvent can be used, and water is preferable. For example, the cationic polymer is preferably polyethyleneimine, an ion polymer complex formed of a polymer having polyethyleneimine and a carboxylic acid, primary amine-grafted acrylic resins obtained by graft-polymerizing a primary amine with an acrylic main backbone, polyallylamine or a derivative thereof, or aminated phenol. The anionic polymer is preferably poly (meth)acrylic acid or a salt thereof, or a copolymer containing (meth)acrylic acid or a salt thereof as a main component. The crosslinker is preferably at least one selected from the group consisting of a silane coupling agent and a compound having any of functional groups including an isocyanate group, a glycidyl group, a carboxyl group and an oxazoline group. In addition, the phosphoric acid or phosphate is preferably condensed phosphoric acid or a condensed phosphate.

Examples of the corrosion-resistant film include films formed by applying a dispersion of fine particles of a metal oxide such as aluminum oxide, titanium oxide, cerium oxide or tin oxide or barium sulfate in phosphoric acid to the surface of the barrier layer and performing baking treatment at 150° C. or higher.

The corrosion-resistant film may have a laminated structure in which at least one of a cationic polymer and an anionic polymer is further laminated if necessary. Examples of the cationic polymer and the anionic polymer include those described above.

The composition of the corrosion-resistant film can be analyzed by, for example, time-of-flight secondary ion mass spectrometry.

The amount of the corrosion-resistant film to be formed on the surface of the barrier layer 3 in the chemical conversion treatment is not particularly limited, but for example when the coating-type chromate treatment is performed, and it is desirable that the chromic acid compound be contained in an amount of, for example, about 0.5 to 50 mg, preferably about 1.0 to 40 mg, in terms of chromium, the phosphorus compound be contained in an amount of, for example, about 0.5 to 50 mg, preferably about 1.0 to 40 mg, in terms of phosphorus, and the aminated phenol polymer be contained in an amount of, for example, about 1.0 to 200 mg, preferably about 5.0 to 150 mg, per 1 m² of the surface of the barrier layer 3.

The thickness of the corrosion-resistant film is not particularly limited, and is preferably about 1 nm to 20 μm, more preferably about 1 nm to 100 nm, still more preferably about 1 nm to 50 nm from the viewpoint of the cohesive force of the film and the adhesive strength with the barrier layer and the heat-sealable resin layer. The thickness of the corrosion-resistant film can be measured by observation with a transmission electron microscope or a combination of observation with a transmission electron microscope and energy dispersive X-ray spectroscopy or electron beam energy loss spectroscopy. By analyzing the composition of the corrosion-resistant film using time-of-flight secondary ion mass spectrometry, peaks derived from secondary ions from, for example, Ce, P and O (e.g. at least one of Ce₂PO₄⁺, CePO₄⁻ and the like) and secondary ions from, for example, Cr, P and O (e.g. at least one of CrPO₂⁺, CrPO₄⁻ and the like) are detected.

The chemical conversion treatment is performed in the following manner: a solution containing a compound to be used for formation of a corrosion-resistant film is applied to the surface of the barrier layer by a bar coating method, a roll coating method, a gravure coating method, an immersion method or the like, and heating is then performed so that the temperature of the barrier layer is about 70 to about 200° C. The barrier layer may be subjected to a degreasing treatment by an alkali immersion method, an electrolytic cleaning method, an acid cleaning method, an electrolytic acid cleaning method or the like before the barrier layer is subjected to a chemical conversion treatment. When a degreasing treatment is performed as described above, the chemical conversion treatment of the surface of the barrier layer can be further efficiently performed. When an acid degreasing agent with a fluorine-containing compound dissolved in an inorganic acid is used for degreasing treatment, not only a metal foil degreasing effect can be obtained but also a metal fluoride can be formed as a passive state, and in this case, only degreasing treatment may be performed.

### Heat-Sealable Resin Layer 4

In the exterior material for electrical storage devices according to the present disclosure, the heat-sealable resin layer 4 is a layer (sealant layer) which corresponds to an innermost layer and performs a function of hermetically sealing the electrical storage device element by heat-sealing the heat-sealable resin layer during construction of the electrical storage device.

In the present disclosure, the heat-sealable resin layer 4 has a molecular weight of 150,000 or more in terms of a peak value in a differential molecular weight distribution curve (molecular weight at which the value obtained by differentiating the concentration fraction with respect to the logarithmic value of the molecular weight reaches a peak value) obtained by high-temperature gel permeation chromatography measurement. From the viewpoint of more suitably exhibiting the effect of the present disclosure, the molecular weight is preferably about 160,000 or more, more preferably about 165,000 or more, still more preferably about 170,000 or more. The molecular weight is, for example, about 250,000 or less, about 220,000 or less, about 200,000 or less, or 198,000 or less. The molecular weight is preferably in the range of 150,000 to 250,000, about 150,000 to 220,000, about 150,000 to 200,000, about 150,000 to 198,000, about 160,000 to 250,000, about 160,000 to 220,000, about 160,000 to 200,000, about 160,000 to 198,000, about 165,000 to 250,000, about 165,000 to 220,000, about 165,000 to 200,000, about 165,000 to 198,000, about 170,000 to 250,000, about 170,000 to 220,000, about 170,000 to 200,000, or about 170,000 to 198,000. Since the molecular weight is about 150,000 or more, the electrical storage device is more suitably sealed by the exterior material for electrical storage devices until the electrical storage device reaches a high temperature (for example, about 100° C.). As characteristics related to the molecular weight of resin, the number average molecular weight (Mn), the weight average molecular weight (Mw), Mw/Mn and the like are often used. However, as a result of conducting studies by the inventors of the present disclosure, an evident correlation with these characteristics has not been found in a form in which an electrical storage device is suitably sealed by an exterior material for electrical storage devices and a form in which an electrical storage device is not suitably sealed by an exterior material for electrical storage devices. On the other hand, as in the present disclosure, an evident correlation has been found between the peak value in the differential molecular weight distribution curve and the sealability.

### Measurement of Molecular Weight as Peak Value in Differential Molecular Weight Distribution Curve

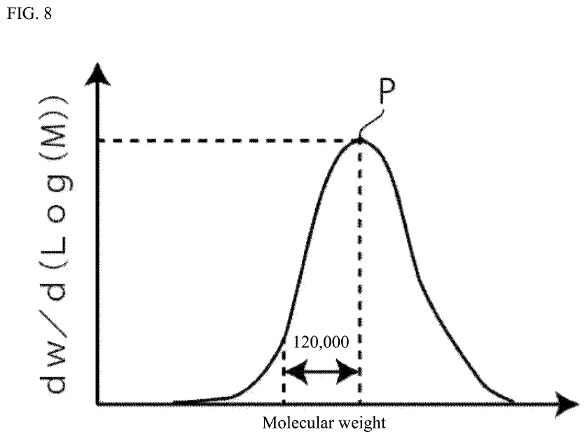

The heat-sealable resin layer is acquired from the exterior material for electrical storage devices and taken as a measurement sample. For each measurement sample, the concentration fraction of each molecular weight is sequentially integrated by high-temperature gel permeation chromatography (for example, high-temperature GPC SSC-7120 HT-GPC System manufactured by Senshu Scientific Co., Ltd.) with each molecular weight (logarithmic value) in the horizontal axis under the following measurement conditions to obtain an integral molecular weight distribution curve. A differential molecular weight distribution curve is acquired by determining the curve differential value at each molecular weight, and a molecular weight in terms of a peak value in the vertical axis (concentration fraction: dw/d (Log (M))) is determined. As shown in the schematic diagram of FIG. 8, the differential molecular weight distribution curve is a graph in which the horizontal axis represents the molecular weight and the vertical axis represents a value obtained by differentiating the concentration fraction with respect to the logarithmic value of the molecular weight. The molecular weight at a position where the value obtained by differentiating the concentration fraction with respect to the logarithmic value of the molecular weight is the highest is a molecular weight in terms of a peak value in the differential molecular weight distribution curve (see position P in FIG. 8).

### Measurement Conditions

### Pretreatment

The measurement sample is dissolved in a solvent (o-dichlorobenzene at 145° C.).

The resulting solution is immobilized for 1 hour and stirred for 1 hour.

Next, the solution is filtered under pressure with membrane filters having filter pore sizes of 1.0 μm and 0.5 μm, respectively.

### Measurement

A sample in which a measurement sample is dissolved in a solvent (o-dichlorobenzene) is prepared by the pretreatment, and a differential molecular weight distribution curve is acquired by high-temperature gel permeation chromatography (high-temperature GPC SSC-7120 HT-GPC System manufactured by Senshu Scientific Co., Ltd.). The amount of injection of the sample is set to 300 μL, HT-G is used as a guard column, two HT-806Ms are used as columns, the column temperature is set to 145° C., o-dichlorobenzene (containing 0.025 mass % of BHT (butylated hydroxytoluene)) is used for the mobile phase, the flow rate is set to 1.0 mL/min, a differential refractometer is used as detector, the molecular weight is calibrated in terms of polystyrene, and the covered molecular weight is set within the range of 1,000 to 20,000,000.

In the present disclosure, the following TL value of the heat-sealable resin layer 4 is preferably 2.80 or less, more preferably 2.50 or less, still more preferably 2.00 or less. The lower limit of the following TL value is 1.00 or more. A small TL value of the heat-sealable resin layer 4 has an advantage that a curve from a concentration fraction of a molecular weight with the highest concentration fraction to a concentration fraction of a resin having a low molecular weight (specifically, a molecular weight lower by 120,000), among resins contained in the heat-sealable resin layer 4, has a gentle slope, and when exterior materials for electrical storage devices with a size usable for an individual electrical storage device are cut out from an exterior material for electrical storage devices with a large area, there is little variation in heat-sealing strength among individual exterior materials for electrical storage devices.

### Calculation of TL Value

In (Measurement of molecular weight as peak value in differential molecular weight distribution curve) above, a value (referred to a TL value) is calculated by dividing the concentration fraction of a molecular weight, at which the concentration fraction reaches a peak value, by the concentration fraction of a molecular weight lower by 120,000 than the molecular weight at which the concentration fraction reaches a peak value, in the differential molecular weight distribution curve with the molecular weight (logarithmic value) in the horizontal axis and the concentration fraction of the molecular weight in the vertical axis. That is, the TL value is calculated by the following equation

TL value=(concentration fraction of molecular weight, at which concentration fraction reaches peak value)/(concentration fraction of molecular weight lower by 120,000 than molecular weight at which concentration fraction reaches peak value)

From the viewpoint of more suitably exhibiting the effect of the invention of the present disclosure, it is preferable that a melting peak temperature of 130° C. or lower is observed in the heat-sealable resin layer 4 in the exterior material for electrical storage devices according to the present disclosure. From the same viewpoint, the melting peak temperature is preferably about 100° C. or higher, more preferably about 110° C. or higher, still more preferably about 120° C. or higher, and is preferably about 150° C. or lower, more preferably about 145° C. or lower, more preferably about 138° C. or lower, still more preferably about 128° C. or lower. The melting peak point is preferably in the range of about 100 to 150° C., about 100 to 145° C., about 100 to 138° C., about 100 to 130° C., about 100 to 128° C., about 110 to 150° C., about 110 to 145° C., about 110 to 138° C., about 110 to 130° C., about 110 to 128° C., about 120 to 150° C., about 120 to 145° C., about 120 to 138° C., about 120 to 130° C., or about 120 to 138° C. There may be one or more melting peak temperatures. For example, in the heat-sealable resin layer 4, a melting peak temperature of higher than 130° C. may be observed, in addition to a melting peak temperature of 130° C. or lower. From the viewpoint of more suitably exhibiting the effect of the invention of the present disclosure, all melting peak temperatures observed in the heat-sealable resin layer 4 are preferably 145° C. or lower. A method for measuring the melting peak temperature is as follows.

### Measurement of Melting Peak Temperature

The heat-sealable resin layer is acquired from the exterior material for electrical storage devices and taken as a measurement sample. For the measurement sample, the melting peak temperature is measured in accordance with the provisions of JIS K 7121: 2012 (Testing Methods for Transition Temperatures of Plastics (Amendment 1 of JIS K 7121: 1987)). The measurement is performed with a differential scanning calorimeter (DSC, for example, Differential Scanning calorimeter Q200 manufactured by TA Instruments).

From the viewpoint of more suitably exhibiting the effect of the invention of the present disclosure, the difference between the melting peak temperature and the softening point of the heat-sealable resin layer 4 is preferably about 30° C. or less, more preferably about 20° C. or less, still more preferably about 10° C. or less, still more preferably about 5° C. or less in the exterior material for electrical storage devices. The melting peak temperature is preferably in the range of about 0 to 30° C., about 0 to 20° C., about 0 to 10° C., or about 0 to 5° C. In general, a resin having a temperature higher than the glass transition point tends to soften as the temperature becomes higher. When the temperature of the resin exceeds the melting point, the physical properties of the resin rapidly change, and the value of sealing strength at the melting point becomes a very small. The sealing strength of the heat-sealable resin layer tends to decrease as the resin softens. If softening of the resin proceeds at a temperature significantly lower than the melting point, the exterior material for electrical storage devices may be opened at a temperature lower than a desired temperature. For this reason, it is desirable that the difference between the melting peak temperature and the softening point of the heat-sealable resin layer 4 satisfy the above-described condition, with the difference being as small as possible. Methods for measuring the melting peak temperature and the softening point of the heat-sealable resin layer 4 are as follows.

### Measurement of Softening Point

In the measurement of the softening point of the exterior material for an electric storage device, first, a probe 11 is installed on a surface of the heat-sealable resin layer 4 at a cross-section of the exterior material for electrical storage devices as shown in, for example, the conceptual diagram of FIG. 7 (measurement start A in FIG. 7). The cross-section here is a portion in which a cross-section of the heat-sealable resin layer 4, obtained by performing cutting in the thickness direction of the exterior material for electrical storage devices, is exposed. FIG. 7 shows a probe installation position 4a. The battery packaging material can be cut using a commercially available rotary microtome. When the amount of displacement is measured for an exterior material for electrical storage devices which is used for a battery containing an electrolyte and the like, the amount of displacement is measured with cutting performed in the thickness direction as in the above described method for a portion of the exterior material for electrical storage devices to which the heat-sealable resin layer is not sealed. As an atomic force microscope to which a cantilever with a heating mechanism is attached, for example, afm plus System manufactured by ANASYS INSTRUMENTS is used, and as a probe, a cantilever manufactured by ANASYS INSTRUMENTS: ThermaLever AN2-200 (spring constant: 0.5 to 3 N/m) may be used. The radius of tip of a probe 11 is 30 nm or less, the set value of deflection of the probe 11 is -4 V, and the temperature rise rate is 5° C./min. Next, the probe is heated in this state, and consequently, by heat from the probe, a surface of the heat-sealable resin layer 4 is expanded to push up the probe 11 as described in B of FIG. 7, so that the position of the probe 11 becomes higher than an initial value (position at which the temperature of the probe is 40° C.). When the heating temperature increases, the heat-sealable resin layer 4 softens, the probe 11 sticks into the heat-sealable resin layer 4 as shown in C of FIG. 7, so that the position of the probe 11 is lowered. The temperature at which the position is lowered (point at which a change from rising to lowering starts) is defined as a softening point of the exterior material for electrical storage devices. The exterior material for electrical storage devices to be measured is placed at room temperature (25° C.), the probe heated to 40° C. is installed on the surface of the heat-sealable resin layer 4, and measurement is started.

The resin forming the heat-sealable resin layer 4 is not particularly limited as long as it can be heat-sealed, a resin containing a polyolefin backbone such as a polyolefin or an acid-modified polyolefin is preferable. The resin forming the heat-sealable resin layer 4 can be confirmed to contain a polyolefin backbone by an analysis method such as infrared spectroscopy or gas chromatography-mass spectrometry. It is preferable that a peak derived from maleic anhydride is detected when the resin forming the heat-sealable resin layer 4 is analyzed by infrared spectroscopy. For example, when a maleic anhydride-modified polyolefin is measured by infrared spectroscopy, peaks derived from maleic anhydride are detected near wavenumbers of 1760 cm⁻¹ and 1780 cm⁻¹. When the heat-sealable resin layer 4 is a layer formed of a maleic anhydride-modified polyolefin, a peak derived from maleic anhydride is detected when measurement is performed by infrared spectroscopy. However, if the degree of acid modification is low, the peaks may be too small to be detected. In that case, the peaks can be analyzed by nuclear magnetic resonance spectroscopy.

Specific examples of the polyolefin include polyethylenes such as low-density polyethylene, medium-density polyethylene, high-density polyethylene and linear low-density polyethylene; ethylene-α-olefin copolymers; polypropylene such as homopolypropylene, block copolymers of polypropylene (e.g., block copolymers of propylene and ethylene) and random copolymers of polypropylene (e.g., random copolymers of propylene and ethylene); propylene-α-olefin copolymers; and terpolymers of ethylene-butene-propylene. Of these, polypropylene is preferable. The polyolefin resin in the case of a copolymer may be a block copolymer or a random copolymer. These polyolefin-based resins may be used alone, or may be used in combination of two or more thereof.

The polyolefin may be a cyclic polyolefin. The cyclic polyolefin is a copolymer of an olefin and a cyclic monomer, and examples of the olefin as a constituent monomer of the cyclic polyolefin include ethylene, propylene, 4-methyl-1-pentene, styrene, butadiene and isoprene. Examples of the cyclic monomer as a constituent monomer of the cyclic polyolefin include cyclic alkenes such as norbornene; cyclic dienes such as cyclopentadiene, dicyclopentadiene, cyclohexadiene and norbornadiene. Among these polyolefins, cyclic alkenes are preferable, and norbornene is more preferable.

The acid-modified polyolefin is a polymer with the polyolefin modified by subjecting the polyolefin to block polymerization or graft polymerization with an acid component. As the polyolefin to be acid-modified, the above-mentioned polyolefins, copolymers obtained by copolymerizing polar molecules such as acrylic acid or methacrylic acid with the above-mentioned polyolefins, polymers such as crosslinked polyolefins, or the like can also be used. Examples of the acid component to be used for acid modification include carboxylic acids such as maleic acid, acrylic acid, itaconic acid, crotonic acid, maleic anhydride and itaconic anhydride, and anhydrides thereof.

The acid-modified polyolefin may be an acid-modified cyclic polyolefin. The acid-modified cyclic polyolefin is a polymer obtained by copolymerizing a part of monomers forming the cyclic polyolefin in place of an acid component, or block-polymerizing or graft-polymerizing an acid component with the cyclic polyolefin. The cyclic polyolefin to be modified with an acid is the same as described above. The acid component to be used for acid modification is the same as the acid component used for modification of the polyolefin.

Examples of preferred acid-modified polyolefins include polyolefins modified with a carboxylic acid or an anhydride thereof, polypropylene modified with a carboxylic acid or an anhydride thereof, maleic anhydride-modified polyolefins, and maleic anhydride-modified polypropylene.

The heat-sealable resin layer 4 may be formed from one resin alone, or may be formed from a blend polymer obtained by combining two or more resins. Further, the heat-sealable resin layer 4 may be composed of only one layer, or may be composed of two or more layers with the same resin component or different resin components.

The heat-sealable resin layer 4 may contain a slipping agent etc. if necessary. When the heat-sealable resin layer 4 contains a slipping agent, the moldability of the exterior material for electrical storage devices can be improved. The slipping agent is not particularly limited, and a known slipping agent can be used. The slipping agents may be used alone, or may be used in combination of two or more thereof.

The slipping agent is not particularly limited, and is preferably an amide-based slipping agent. Specific examples of the slipping agent include those exemplified for the base material layer 1. The slipping agents may be used alone, or may be used in combination of two or more thereof.

When a slipping agent is present on the surface of the heat-sealable resin layer 4, the amount of the slipping agent present is not particularly limited, and is preferably about 10 to 50 mg/m², more preferably about 15 to 40 mg/m² from the viewpoint of improving the moldability of the exterior material for electrical storage devices.

The slipping agent present on the surface of the heat-sealable resin layer 4 may be one obtained by exuding the slipping agent contained in the resin forming the heat-sealable resin layer 4, or one obtained by applying a slipping agent to the surface of the heat-sealable resin layer 4.

The thickness of the heat-sealable resin layer 4 is not particularly limited as long as the heat-sealable resin layers are heat-sealed to each other to perform a function of sealing the electrical storage device element, and the thickness is, for example, about 100 μm or less, preferably about 85 μm or less, more preferably about 15 to 85 μm. For example, when the thickness of the adhesive layer 5 described later is 10 μm or more, the thickness of the heat-sealable resin layer 4 is preferably about 85 μm or less, more preferably about 15 to 45 μm. For example, when the thickness of the adhesive layer 5 described later is less than 10 μm or the adhesive layer 5 is not provided, the thickness of the heat-sealable resin layer 4 is preferably about 20 μm or more, more preferably about 35 to 85 μm.

### Adhesive Layer 5

In the exterior material for electrical storage devices according to the present disclosure, the adhesive layer 5 is a layer provided between the barrier layer 3 (or corrosion-resistant film) and the heat-sealable resin layer 4 if necessary for firmly bonding these layers to each other.

From the viewpoint of more suitably exhibiting the effect of the invention of the present disclosure, the temperature at which the melting peak is observed in the adhesive layer 5 is preferably about 120° C. or higher, more preferably about 130° C. or higher, more preferably about 140° C. or higher, still more preferably about 150° C. or higher, and preferably about 170° C. or lower, more preferably 150° C. or lower, and is preferably in the range of about 120 to 170° C., about 120 to 150° C., about 130 to 170° C., about 130 to 150° C., about 140 to 170° C., about 140 to 150° C., or about 150 to 170° C. There may be one or more melting peak temperatures. A melting peak temperature outside the range of 120 to 170° C. may be observed in the adhesive layer 5. However, from the viewpoint of more suitably exhibiting the effect of the invention of the present disclosure, all melting peak temperatures observed in the adhesive layer 5 are preferably in the range of 120 to 170° C. The melting peak temperature is measured by the method described in the section of (Melting peak temperature) above except that the adhesive layer is acquired from the exterior material for electrical storage devices, and taken as a measurement sample.

The adhesive layer 5 is formed from a resin capable of bonding the barrier layer 3 and the heat-sealable resin layer 4 to each other. A thermoplastic resin is preferably used for formation of the adhesive layer 5. It is preferable that the resin for use in formation of the adhesive layer 5 contains a polyolefin backbone. Examples thereof include the polyolefins and acid-modified polyolefins exemplified for the heat-sealable resin layer 4 described above. On the other hand, from the viewpoint of firmly bonding the barrier layer 3 and the adhesive layer 5 to each other, it is preferable that the adhesive layer 5 contains an acid-modified polyolefin. Examples of the acid modifying component include dicarboxylic acids such as maleic acid, itaconic acid, succinic acid and adipic acid, anhydrides thereof, acrylic acid, and methacrylic acid, and maleic anhydride is most preferable from the viewpoint of ease of modification, general-purpose property, and the like. From the viewpoint of the heat resistance of the exterior material for electrical storage devices, the olefin component is preferably a polypropylene-based resin, and it is most preferable that the adhesive layer 5 contains maleic anhydride-modified polypropylene.

The resin forming the adhesive layer 5 can be confirmed to contain a polyolefin backbone by an analysis method such as infrared spectroscopy, gas chromatography-mass s pectrometry, and the analysis method is not particularly limited. The resin forming the adhesive layer 5 is confirmed to contain an acid-modified polyolefin, for example, when peaks derived from maleic anhydride are detected near wavenumbers of 1760 cm⁻¹ and 1780 cm⁻¹ when a maleic anhydride-modified polyolefin is measured by infrared spectroscopy. However, if the degree of acid modification is low, the peaks may be too small to be detected. In that case, the peaks can be analyzed by nuclear magnetic resonance spectroscopy.

The thickness of the adhesive layer 5 is preferably about 60 μm or less, about 50 μm or less, or about 45 μm or less. The thickness of the adhesive layer 5 is preferably about 10 μm or more, about 20 μm or more, about 25 μm or more, or about 30 μm or more. The thickness of the adhesive layer 5 is preferably in the range of about 10 to 60 μm, about 10 to 50 μm, about 10 to 45 μm, about 20 to 60 μm, about 20 to 50 μm, about 20 to 45 μm, about 25 to 60 μm, about 25 to 50 μm, about 25 to 45 μm, about 30 to 60 μm, about 30 to 50 μm, or about 30 to 45 μm. The adhesive layer 5 can be formed by, for example, extrusion molding of the heat-sealable resin layer 4 and the adhesive layer 5.

### Surface Coating Layer 6

The exterior material for electrical storage devices according to the present disclosure may include a surface coating layer 6 on the base material layer 1 (on a side opposite to the barrier layer 3 from the base material layer 1) if necessary for the purpose of improving at least one of designability, electrolytic solution resistance, scratch resistance, moldability and the like. The surface coating layer 6 is a layer located on the outermost layer side of the exterior material for electrical storage devices when the electrical storage device is constructed using the exterior material for electrical storage devices.

The surface coating layer 6 can be formed from, for example, a resin such as polyvinylidene chloride, polyester, polyurethane, acrylic resin or epoxy resin.

When the resin forming the surface coating layer 6 is a curable resin, the resin may be any of a one-liquid curable type and a two-liquid curable type, and is preferably a two-liquid curable type. Examples of the two-liquid curable resin include two-liquid curable polyurethane, two-liquid curable polyester and two-liquid curable epoxy resins. Of these, two-liquid curable polyurethane is preferable.

Examples of the two-liquid curable polyurethane include polyurethane which contains a first component containing a polyol compound and a second component containing an isocyanate compound. The polyurethane is preferably a two-liquid curable polyurethane adhesive having polyol such as polyester polyol, polyether polyol or acrylic polyol as a first component, and aromatic or aliphatic polyisocyanate as a second component. Examples of the polyurethane include polyurethane containing an isocyanate compound and a polyurethane compound obtained by reacting a polyol compound with an isocyanate compound in advance. Examples of the polyurethane include polyurethane containing a polyurethane compound and a polyurethane compound obtained by reacting a polyol compound with an isocyanate compound in advance. Examples of the polyurethane include polyurethane obtained by reacting a polyol compound with an isocyanate compound to form a polyurethane compound in advance, and reacting the polyurethane compound with moisture in the air or the like. It is preferable that polyester polyol having a hydroxyl group in the side chain in addition to a hydroxyl group at the end of the repeating unit is used as the polyol compound. Examples of the second component include aliphatic, alicyclic, aromatic and araliphatic isocyanate-based compounds. Examples of the isocyanate-based compound include hexamethylene diisocyanate (HDI), xylylene diisocyanate (XDI), isophorone diisocyanate (IPDI), hydrogenated XDI (H6XDI), hydrogenated MDI (H12MDI), tolylene diisocyanate (TDI), diphenylmethane diisocyanate (MDI) and naphthalene diisocyanate (NDI). Examples of the isocyanate-based compound also include polyfunctional isocyanate-modified products of one or more of these diisocyanates can be mentioned. It is also possible to use a multimer (e.g. a trimer) as the polyisocyanate compound. Examples of the multimer include adducts, biurets, and nurates. The aliphatic isocyanate-based compound is an isocyanate having an aliphatic group and having no aromatic ring, the alicyclic isocyanate-based compound is an isocyanate having an alicyclic hydrocarbon group, and the aromatic isocyanate-based compound is an isocyanate having an aromatic ring. Since the surface coating layer 6 is formed of polyurethane, excellent electrolytic solution resistance is imparted to the exterior material for electrical storage devices.

If necessary, the surface coating layer 6 may contain additives such as the slipping agent, an anti-blocking agent, a matting agent, a flame retardant, an antioxidant, a tackifier and an anti-static agent on at least one of the surface and the inside of the surface coating layer 6 according to the functionality and the like to be imparted to the surface coating layer 6 and the surface thereof. The additives are in the form of, for example, fine particles having an average particle diameter of about 0.5 nm to 5 μm. The average particle diameter of the additives is a median diameter measured by a laser diffraction/scattering particle diameter distribution measuring apparatus.

The additives may be either inorganic substances or organic substances. The shape of the additive is not particularly limited, and examples thereof include a spherical shape, a fibrous shape, a plate shape, an amorphous shape and a scaly shape.

Specific examples of the additives include talc, silica, graphite, kaolin, montmorillonite, mica, hydrotalcite, silica gel, zeolite, aluminum hydroxide, magnesium hydroxide, zinc oxide, magnesium oxide, aluminum oxide, neodymium oxide, antimony oxide, titanium oxide, cerium oxide, calcium sulfate, barium sulfate, calcium carbonate, calcium silicate, lithium carbonate, calcium benzoate, calcium oxalate, magnesium stearate, alumina, carbon black, carbon nanotubes, high-melting-point nylons, acrylate resins, crosslinked acryl, crosslinked styrene, crosslinked polyethylene, benzoguanamine, gold, aluminum, copper and nickel. The additives may be used alone, or may be used in combination of two or more thereof. Of these additives, silica, barium sulfate and titanium oxide are preferable from the viewpoint of dispersion stability, costs, and so on. The surface of the additive may be subjected to various kinds of surface treatments such as insulation treatment and dispersibility enhancing treatment.

The method for forming the surface coating layer 6 is not particularly limited, and examples thereof include a method in which a resin for forming the surface coating layer 6 is applied. When the additive is added to the surface coating layer 6, a resin mixed with the additive may be applied.

The thickness of the surface coating layer 6 is not particularly limited as long as the above-mentioned function as the surface coating layer 6 is performed, and it is, for example, about 0.5 to 10 μm, preferably about 1 to 5 μm.

### 3. Method for Manufacturing Exterior Material for Electrical Storage Devices

The method for manufacturing an exterior material for electrical storage devices is not particularly limited as long as a laminate is obtained in which the layers of the exterior material for electrical storage devices according to the present disclosure are laminated. Examples thereof include a method including the step of laminating at least the base material layer 1, the barrier layer 3 and the heat-sealable resin layer 4 in this order. That is, the method for manufacturing an exterior material for electrical storage devices includes the step of laminating at least a base material layer, a barrier layer and a heat-sealable resin layer in this order to obtain a laminate, and the heat-sealable resin layer of the exterior material for electrical storage devices has a molecular weight of 150,000 or more in terms of a peak value in a differential molecular weight distribution curve obtained by high-temperature gel permeation chromatography measurement.

An example of the method for manufacturing the exterior material for electrical storage devices of the present invention is as follows. First, a laminate including the base material layer 1, the adhesive agent layer 2 and the barrier layer 3 in this order (hereinafter, the laminate may be described as a “laminate A”) is formed. Specifically, the laminate A can be formed by a dry lamination method in which an adhesive to be used for formation of the adhesive agent layer 2 is applied onto the base material layer 1 or the barrier layer 3, the surface of which is subjected to a chemical conversion treatment if necessary, using a coating method such as a gravure coating method or a roll coating method, and dried, the barrier layer 3 or the base material layer 1 is then laminated, and the adhesive agent layer 2 is cured.

Then, the heat-sealable resin layer 4 is laminated on the barrier layer 3 of the laminate A. When the heat-sealable resin layer 4 is laminated directly on the barrier layer 3, the heat-sealable resin layer 4 may be laminated onto the barrier layer 3 of the laminate A by a method such as a thermal lamination method or an extrusion lamination method. When the adhesive layer 5 is provided between the barrier layer 3 and the heat-sealable resin layer 4, mention is made of, for example, (1) a method in which the adhesive layer 5 and the heat-sealable resin layer 4 are extruded to be laminated on the barrier layer 3 of the laminate A (extrusion lamination method or tandem lamination method); (2) a method in which the adhesive layer 5 and the heat-sealable resin layer 4 are laminated to form a laminate separately, and the laminate is laminated on the barrier layer 3 of the laminate A by a thermal lamination method, or a method in which a laminate with the adhesive layer 5 laminated on the barrier layer 3 of the laminate A is formed, and laminated to the heat-sealable resin layer 4 by a thermal lamination method; (3) a method in which the melted adhesive layer 5 is poured between the barrier layer 3 of the laminate A and the heat-sealable resin layer 4 formed in a sheet shape beforehand, and simultaneously the laminate A and the heat-sealable resin layer 4 are bonded to each other with the adhesive layer 5 interposed therebetween (sandwich lamination); and (4) an adhesive for forming the adhesive layer 5 is applied by solution coating and dried or baked to laminate the adhesive on the barrier layer 3 of the laminate A, and the heat-sealable resin layer 4 formed in a sheet shape in advance is laminated on the adhesive layer 5.

When the surface coating layer 6 is provided, the surface coating layer 6 is laminated on a surface of the base material layer 1 on a side opposite to the barrier layer 3. The surface coating layer 6 can be formed by, for example, coating a surface of the base material layer 1 with the resin that forms the surface coating layer 6. The order of the step of laminating the barrier layer 3 on a surface of the base material layer 1 and the step of laminating the surface coating layer 6 on a surface of the base material layer 1 is not particularly limited. For example, the surface coating layer 6 may be formed on a surface of the base material layer 1, followed by forming the barrier layer 3 on a surface of the base material layer 1 on a side opposite to the surface coating layer 6.

As described above, a laminate including the surface coating layer 6 provided if necessary, the base material layer 1, the adhesive agent layer 2 provided if necessary, the barrier layer 3, the adhesive layer 5 provided if necessary, and the heat-sealable resin layer 4 in this order is formed, and the laminate may be further subjected to a heating treatment for strengthening the bondability of the adhesive agent layer 2 and the adhesive layer 5 provided if necessary.

In the exterior material for electrical storage devices, the layers forming the laminate may be subjected to surface activation treatment such as corona treatment, blast treatment, oxidation treatment or ozone treatment if necessary to improve processing suitability. For example, by subjecting a surface of the base material layer 1, which is opposite to the barrier layer 3, to a corona treatment, the ink printability of the surface of the base material layer 1 can be improved.

### 4. Uses of Exterior Material for Electrical Storage Devices

The exterior material for electrical storage devices according to the present disclosure is used as a packaging for hermetically sealing and storing electrical storage device elements such as a positive electrode, a negative electrode, and an electrolyte. That is, in a packaging formed of the exterior material for electrical storage devices of the present disclosure, an electrical storage device element including at least a positive electrode, a negative electrode, and an electrolyte can be housed to obtain an electrical storage device.

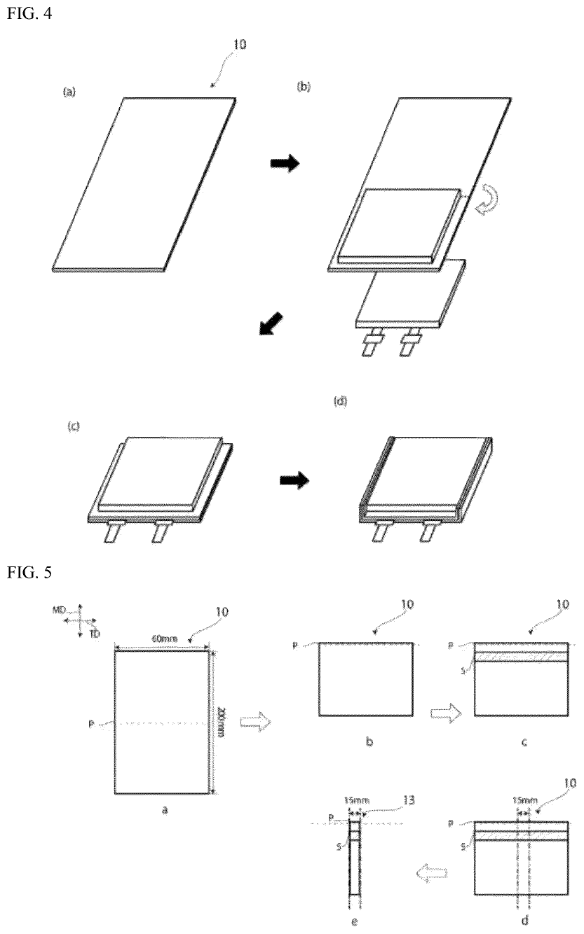

Specifically, an electrical storage device element including at least a positive electrode, a negative electrode, and an electrolyte is covered with the exterior material for electrical storage devices according to the present disclosure such that a flange portion (region where a heat-sealable resin layer is in contact with itself) can be formed on the periphery of the electrical storage device element while a metal terminal connected to each of the positive electrode and the negative electrode protrudes to the outside, and the heat-sealable resin layer at the flange portion is heat-sealed with itself, thereby providing an electrical storage device using the exterior material for electrical storage devices. When the electrical storage device element is stored in the packaging formed of the exterior material for electrical storage devices according to the present disclosure, the packaging is formed in such a manner that the heat-sealable resin portion of the exterior material for electrical storage devices according to the present disclosure is on the inner side (a surface contacting the electrical storage device element). The heat-sealable resin layers of two exterior materials for electrical storage devices may be superposed in such a manner as to face each other, followed by heat-sealing the peripheral edge portions of the superposed exterior materials for electrical storage devices to form a packaging. Alternatively, as in the example shown in FIG. 4, one exterior material for electrical storage devices may be folded over itself, followed by heat-sealing the peripheral edge portions to form a packaging. When the exterior material is folded over itself, a packaging may be formed by three-side sealing with the exterior material heat-sealed at sides other than the folding side as in the example shown in FIG. 4, or may be subjected to four-side sealing with the exterior material folded in such a manner that a flange portion can be formed. In the exterior material for electrical storage devices, a concave portion for housing an electrical storage device element may be formed by deep drawing molding or bulging molding. As in the example shown in FIG. 4, one exterior material for electrical storage devices may be provided with a concave portion while the other exterior material for electrical storage devices is not provided a concave portion, or the other exterior material for electrical storage devices may also be provided with a concave portion.

The exterior material for electrical storage devices according to the present disclosure can be suitably used for electrical storage devices such as batteries (including condensers, capacitors and the like.). The exterior material for electrical storage devices according to the present disclosure may be used for either primary batteries or secondary batteries, and is preferably used for secondary batteries. The type of a secondary battery to which the exterior material for electrical storage devices according to the present disclosure is applied is not particularly limited, and examples thereof include lithium ion batteries, lithium ion polymer batteries, solid-state batteries, lead storage batteries, nickel-hydrogen storage batteries, nickel-cadmium storage batteries, nickel-iron storage batteries, nickel-zinc storage batteries, silver oxide-zinc storage batteries, metal-air batteries, polyvalent cation batteries, condensers and capacitors. Of these secondary batteries, preferred subjects to which the exterior material for electrical storage devices according to the present disclosure is applied include lithium ion batteries and lithium ion polymer batteries.

### EXAMPLES

Hereinafter, the present disclosure will be described in detail by way of examples and comparative examples. However, the present disclosure is not limited to examples.

### Manufacturing of Exterior Material for Electrical Storage Devices

### Examples 1 to 4

A stretched nylon (ONy) film (thickness: 25 μm) was provided as a base material layer. In addition, an aluminum foil (JIS H4160:1994 A8021 H-O (thickness: 40 μm)) was prepared as a barrier layer. Next, using a two-liquid urethane adhesive (polyol compound and aromatic isocyanate compound), the base material layer and the barrier layer were bonded to each other by a dry lamination method, and aging treatment was performed to prepare a laminate of base material layer (thickness: 25 μm)/adhesive agent layer (thickness after curing: 3 μm)/barrier layer (thickness: 40 μm). Both surfaces of the aluminum foil are subjected to chemical conversion treatment. The chemical conversion treatment of the aluminum foil was performed by applying to both the surfaces of the aluminum foil a treatment liquid including a phenol resin, a chromium fluoride compound and phosphoric acid using a roll coating method in such a manner that the application amount of chromium was 10 mg/m² (dry mass), and performing baking.

Next, maleic anhydride-modified polypropylene as an adhesive layer (thickness: 23 μm) (PPa1 or PPa2 in Table 1) and random polypropylene as a heat-sealable resin layer (thickness: 22 μm) (PP1, PP2, PP3 or PP4 in Table 1) were co-extruded onto the barrier layer of the obtained laminate to obtain an exterior material for electrical storage devices in which a base material layer (thickness: 25 μm), an adhesive agent layer (3 μm), a barrier layer (40 μm), an adhesive layer (23 μm) and a heat-sealable resin layer (22 μm) were laminated in this order.

As random polypropylene PP1, PP2, PP3 or PP4 to be used for the heat-sealable resin layer in Examples 1 to 4, a resin having a lower melting peak temperature and a higher molecular weight in terms of a peak value in a differential molecular weight distribution curve as compared to the polypropylene used for the heat-sealable resin layer of the exterior material, and for suppressing thermal decomposition of the random polypropylene, co-extrusion was performed under a lower temperature condition than usual in formation of the heat-sealable resin layer by coextrusion, thereby suppressing a decrease in molecular weight in terms of a peak value in the differential molecular weight distribution curve.

### Comparative Example 1

Except that the temperature at which maleic anhydride-modified polypropylene as an adhesive layer (thickness: 23 μm) (PPa1 in Table 1) and random polypropylene as a heat-sealable resin layer (thickness: 22 μm) (PP1 in Table 1) were co-extruded onto the barrier layer of the obtained laminate was set higher by 30° C. than that in Example 1, the same procedure as in Example 1 was carried out to obtain an exterior material for electrical storage devices in which a base material layer (thickness: 25 μm), an adhesive agent layer (3 μm), a barrier layer (40 μm), an adhesive layer (23 μm) and a heat-sealable resin layer (22 μm) were laminated in this order.

### Comparative Example 2

Except that the temperature at which maleic anhydride-modified polypropylene as an adhesive layer (thickness: 23 μm) (PPa1 in Table 1) and random polypropylene as a heat-sealable resin layer (thickness: 22 μm) (PP2 in Table 1) were co-extruded onto the barrier layer of the obtained laminate was set higher by 30° C. than that in Example 2, the same procedure as in Example 2 was carried out to obtain an exterior material for electrical storage devices in which a base material layer (thickness: 25 μm), an adhesive agent layer (3 μm), a barrier layer (40 μm), an adhesive layer (23 μm) and a heat-sealable resin layer (22 μm) were laminated in this order.

The melting peak temperature of the adhesive layer or the heat-sealable resin layer in each of Examples 1 to 4 and Comparative Examples 1 and 2 is as shown in Table 1. The melting peak temperature was measured by the following method.

### Measurement Of Melting Peak Temperature

The adhesive layer and the heat-sealable resin layer are acquired from the exterior material for electrical storage devices and taken as measurement samples. For each measurement sample, the melting peak temperature was measured in accordance with the provisions of JIS K 7121: 2012 (Testing Methods for Transition Temperatures of Plastics (Amendment 1 of JIS K 7121: 1987)). The measurement was performed with a differential scanning calorimeter (DSC, Differential Scanning calorimeter Q200 manufactured by TA Instruments).

### Measurement of Molecular Weight as Peak Value in Differential Molecular Weight Distribution Curve

The heat-sealable resin layer was acquired from the exterior material for electrical storage devices and taken as a measurement sample. For each measurement sample, the concentration fraction of each molecular weight was sequentially integrated by high-temperature gel permeation chromatography (high-temperature GPC SSC-7120 HT-GPC System manufactured by Senshu Scientific Co., Ltd.) with each molecular weight (logarithmic value) in the horizontal axis under the following measurement conditions to obtain an integral molecular weight distribution curve. A differential molecular weight distribution curve was acquired by determining the curve differential value at each molecular weight, and a molecular weight in terms of a peak value in the vertical axis (dw/d (Log (M))) was determined. As shown in the schematic diagram of FIG. 8, the differential molecular weight distribution curve is a graph in which the horizontal axis represents the molecular weight and the vertical axis represents a value obtained by differentiating the concentration fraction with respect to the logarithmic value of the molecular weight. The molecular weight at a position where the value obtained by differentiating the concentration fraction with respect to the logarithmic value of the molecular weight is the highest is a molecular weight in terms of a peak value in the differential molecular weight distribution curve (see position P in FIG. 8).

### Measurement Conditions

### Pretreatment

The measurement sample is dissolved in a solvent (o-dichlorobenzene at 145° C.).

The resulting solution is immobilized for 1 hour and stirred for 1 hour.

Next, the solution is filtered under pressure with membrane filters having filter pore sizes of 1.0 μm and 0.5 μm, respectively.

### Measurement

A sample in which a measurement sample is dissolved in a solvent (o-dichlorobenzene) is prepared by the pretreatment, and a differential molecular weight distribution curve is acquired by high-temperature gel permeation chromatography (high-temperature GPC SSC-7120 HT-GPC System manufactured by Senshu Scientific Co., Ltd.). The amount of injection of the sample is set to 300 μL, HT-G is used as a guard column, two HT-806Ms are used as columns, the column temperature is set to 145° C., o-dichlorobenzene (containing 0.025 mass % of BHT (butylated hydroxytoluene)) is used for the mobile phase, the flow rate is set to 1.0 mL/min, a differential refractometer is used as detector, the molecular weight is calibrated in terms of polystyrene, and the covered molecular weight is set within the range of 1,000 to 20,000,000.

### Calculation of TL Value

In (Measurement of molecular weight as peak value in differential molecular weight distribution curve) above, a value (referred to a TL value) was calculated by dividing the concentration fraction of a molecular weight, at which the concentration fraction reached a peak value, by the concentration fraction of a molecular weight lower by 120,000 than the molecular weight at which the concentration fraction reached a peak value, in the differential molecular weight distribution curve with the molecular weight (logarithmic value) in the horizontal axis and the concentration fraction of the molecular weight in the vertical axis. The results are shown in Table 1. The smaller the TL value, the gentler the slope of the concentration fraction curve from the concentration fraction of a molecular weight with the highest concentration fraction to the concentration fraction of a resin having a low molecular weight (specifically, a molecular weight lower by 120,000). That is, the TL value is calculated by the following equation.

TL value=(concentration fraction of molecular weight, at which concentration fraction reaches peak value)/(concentration fraction of molecular weight lower by 120,000 than molecular weight at which concentration fraction reaches peak value)

### Measurement of Softening Point

In the measurement of the softening point of the exterior material for an electric storage device, first, a probe 11 was installed on a surface of the heat-sealable resin layer 4 at a cross-section of the exterior material for electrical storage devices as shown in, for example, the conceptual diagram of FIG. 7 (measurement start A in FIG. 7). The cross-section here is a portion in which a cross-section of the heat-sealable resin layer 4, obtained by performing cutting in the thickness direction of the exterior material for electrical storage devices, is exposed. FIG. 7 shows a probe installation position 4a. The cutting was performed using a commercially available rotary microtome. As an atomic force microscope to which a cantilever with a heating mechanism is attached, afm plus System manufactured by ANASYS INSTRUMENTS was used, and as a probe, a cantilever manufactured by ANASYS INSTRUMENTS: ThermaLever AN2-200 (spring constant: 0.5 to 3 N/m) was used. The radius of tip of a probe 11 is 30 nm or less, the set value of deflection of the probe 11 was −4 V, and the temperature rose rate is 5° C./min. Next, the probe was heated in this state, and consequently, by heat from the probe, a surface of the heat-sealable resin layer 4 was expanded to push up the probe 11 as described in B of FIG. 7, so that the position of the probe 11 became higher than an initial value (position at which the temperature of the probe is 40° C.). When the heating temperature increased, the heat-sealable resin layer 4 softened, the probe 11 stuck into the heat-sealable resin layer 4 as shown in C of FIG. 7, so that the position of the probe 11 was lowered. The temperature at which the position is lowered (point at which a change from rising to lowering starts) is defined as a softening point of the exterior material for electrical storage devices. The exterior material for electrical storage devices to be measured was placed at room temperature (25° C.), the probe heated to 40° C. was installed on the surface of the heat-sealable resin layer 4, and measurement was started.

In Example 1, the difference between the melting peak temperature and the softening point of the heat-sealable resin layer was 3° C.

### Measurement of Heat-Sealing Strength

As specified in JIS K 7127: 1999, the sealing strength of the exterior material for electrical storage devices at each of measurement temperatures shown in Table 1 (sample temperature) was measured as follows. A test piece was prepared by cutting the exterior material for electrical storage devices into a strip shape having a width of 15 mm in a transverse direction. Specifically, first, a test piece was obtained by cutting each exterior material for electrical storage devices into a size of 60 mm (transverse direction)×200 mm (machine direction) as shown in FIG. 5 (FIG. 5a). Here, 10 test pieces were respectively acquired from 10 portions (equal intervals) in the width direction of the exterior material for electrical storage devices (width: 1,000 mm). Next, for each test piece, the exterior material for electrical storage devices was double-folded in the machine direction at the position of the fold P (intermediate in the machine direction) in such a manner that the heat-sealable resin layers faced each other (FIG. 5b). The heat-sealable resin layers were heat-sealed on the inner side in the machine direction by about 10 mm from the fold P under the conditions of a seal width of 7 mm, a temperature of 190° C., a surface pressure of 1.0 MPa and 3 seconds (FIG. 5c). In FIG. 5c, the shaded portion S is a heat-sealed portion. Next, a test sample was obtained by cutting the sample in the machine direction (cutting the sample at the position of the two-dot chain line in FIG. 5d) in such a manner that the width in the transverse direction was 15 mm (FIG. 5e). Next, the measurement sample 13 was allowed to stand at each measurement temperature for 2 minutes, and the heat-sealable resin layer at the heat-sealed part was peeled at a speed of 300 mm/min with a tensile tester (AG-Xplus (trade name) manufactured by Shimadzu Corporation) in an environment at each measurement temperature (FIG. 6). The maximum strength during the peeling was taken as heat-sealing strength (N/15 mm). The chuck-to-chuck distance is 50 mm. For each heat-seal strength obtained, the average value for 10 measurement samples and the smallest of the heat-sealing strength values of 10 measurement samples are shown in Table 1. The results are shown in Table 1.

### Measurement of Martens Hardness

The Martens hardness was measured on the basis of an indentation method with a Vickers indenter pressed to a depth of 1 μm in a thickness direction from a surface of each exterior material for electrical storage devices on the heat-sealable resin layer side at a measurement temperature (sample temperature) of 100° C. The measurement conditions are as follows. The Martens hardness was calculated from a load-displacement curve obtained by pressing the Vickers indenter. As a measurement value, an average of values for 10 portions of the surface on the heat-sealable resin layer side was adopted. The Martens hardness is determined by calculating the surface area A (mm²) of the Vickers indenter at the maximum depth of indentation, and dividing the maximum load F (N) by the surface area A (mm²) (F/A). Details of the method for measuring the Martens hardness of the surface of the heat-sealable resin layer are as follows. As a measuring apparatus, PICODENTOR HM-500 manufactured by FISCHER INSTRUMENTS K.K. was used. To one surface of slide glass (76 mm×26 mm×1 mm) to which a double-sided pressure sensitive adhesive tape was attached, the exterior material for electrical storage devices was bonded in such a manner that the heat-sealable resin layer was on a side opposite to the slide glass, thereby obtaining a measurement sample. Next, a heating stage was installed on an ultra-microhardness tester equipped with a Vickers indenter, and the sample was heated for 5 minutes with the stage temperature set to 110° C. Next, the hardness of a surface of the measurement sample on the heat-sealable resin layer side was measured. Table 2 shows the results.

### Measurement Conditions

Indenter: Vickers indenter (facing angle of tip end part of quadrangular pyramid: 136°)
Measurement temperature (sample temperature): 100° C.
Stage temperature: 110° C.
Speed: 1.000 μm/10 sec
Measurement depth: 1.0 μm
Retention time: 5 sec
Speed of recovery from pressed state: 1.000 μm/10 sec

TABLE 1

| | Melting peak | | Molecular weight | | | | | | | | | |
|---|---|---|---|---|---|---|---|---|---|---|---|---|
| | temperature (° C.) | | in terms of peak | | Heat-sealing strength (N/15 mm) | | | | | | | |
| | | Heat- | value in differential | | Measurement temperature | | | | | | | |
| | | sealable | molecular weight | | 25° C. | | 100° C. | | 110° C. | | 120° C. | |
| | Adhesive | resin | distribution curve | | | Mini- | | Mini- | | Mini- | | Mini- |
| | layer | layer | of heat-sealable | TL | Average | mum | Average | mum | Average | mum | Average | mum |
| Table 1 | (resin) | (resin) | resin layer | value | value | value | value | value | value | value | value | value |
| Ex- | 160 | 125 | 168,000 | 1.96 | 102 | 99 | 71 | 66 | 65 | 59 | 11 | 7 |
| ample 1 | (PPa1) | (PP1) | | | | | | | | | | |
| Ex- | 160 | 125 | 193,000 | 1.66 | 108 | 101 | 79 | 75 | 68 | 62 | 35 | 31 |
| ample 2 | (PPa1) | (PP2) | | | | | | | | | | |
| Ex- | 160 | 122/134 | 174,000 | 1.79 | 102 | 98 | 76 | 72 | 61 | 55 | 60 | 41 |
| ample 3 | (PPa1) | (PP3) | | | | | | | | | | |
| Ex- | 125 | 140 | 167,000 | 1.84 | 108 | 97 | 75 | 69 | 71 | 65 | 63 | 55 |
| ample 4 | (PPa2) | (PP4) | | | | | | | | | | |
| Ex- | 160 | 125 | 179,000 | 1.99 | 108 | 107 | 59 | 52 | 52 | 50 | 15 | 5 |
| ample 5 | (PPa1) | (PP5) | | | | | | | | | | |
| Com- | 160 | 125 | 149,000 | 2.93 | 101 | 95 | 65 | 28 | 35 | 15 | 3 | 1 |
| parative | (PPa1) | (PP1) | | | | | | | | | | |
| Ex- | | | | | | | | | | | | |
| ample 1 | | | | | | | | | | | | |
| Com- | 160 | 125 | 147,000 | 3.12 | 105 | 96 | 68 | 55 | 45 | 25 | 8 | 2 |
| parative | (PPa1) | (PP2) | | | | | | | | | | |
| Ex- | | | | | | | | | | | | |
| ample 2 | | | | | | | | | | | | |

In Table 1, the notation “122/134” means that melting peak temperatures were observed at 122° C. and 134° C.

TABLE 2

| | Martens hardness of |
|---|---|
| | heat-sealable resin |
| | layer at 100° C. |
| Table 2 | (Mpa) |
| Example 1 | 17.3 |
| Example 2 | 12.8 |
| Example 3 | 13.0 |
| Example 4 | 11.6 |
| Example 5 | 10.5 |

In the heat-sealable resin layer of the exterior material for electrical storage devices in each of Examples 1 to 4 has a molecular weight of 150,000 or more in terms of a peak value in a differential molecular weight distribution curve obtained by high-temperature gel permeation chromatography measurement. The exterior material for electrical storage devices in each of Examples 1 to 4 had high heat-sealing strength and suitably sealed the contents until the electrical storage device reached a high temperature of 100° C., or even 110° C., although the melting point of the heat-sealable resin layer was low. It can be seen that in the exterior material for electrical storage devices in each of Examples 1 to 4, the difference between the average value and the minimum value of the heat-sealing strength at each measurement temperature is small, there is little variation in quality when exterior materials for electrical storage devices are cut out and used.

As described above, the present disclosure provides the invention of aspects as shown below.

Item 1. An exterior material for electrical storage devices including a laminate including at least a base material layer, a barrier layer and a heat-sealable resin layer in this order,

the heat-sealable resin layer having a molecular weight of 150,000 or more in terms of a peak value in a differential molecular weight distribution curve obtained by high-temperature gel permeation chromatography measurement.

Item 2. The exterior material for electrical storage devices according to item 1, in which a Martens hardness is 10.0 MPa or more as measured on the basis of an indentation method with a Vickers indenter pressed to a depth of 1 μm in a thickness direction from a surface of the exterior material for electrical storage devices on the heat-sealable resin layer side at a measurement temperature of 100° C.

Item 3. An exterior material for electrical storage devices including a laminate including at least a base material layer, a barrier layer and a heat-sealable resin layer in this order,

in which a Martens hardness is 10.0 MPa or more as measured on the basis of an indentation method with a Vickers indenter pressed to a depth of 1 μm in a thickness direction from a surface of the exterior material for electrical storage devices on the heat-sealable resin layer side at a measurement temperature of 100° C.

Item 4. The exterior material for electrical storage devices according to any one of items 1 to 3, in which a TL value calculated by dividing a concentration fraction of a molecular weight, at which the concentration fraction reaches a peak value, by a concentration fraction of a molecular weight lower by 120,000 than the molecular weight at which the concentration fraction reaches a peak value, in the differential molecular weight distribution curve with the molecular weight (logarithmic value) in the horizontal axis and the concentration fraction of the molecular weight in the vertical axis is 1.00 or more and 2.80 or less.

Item 5. The exterior material for electrical storage devices according to any one of items 1 to 4, in which a melting peak temperature of 130° C. or lower is observed in the heat-sealable resin layer.

Item 6. The exterior material for electrical storage devices according to any one of items 1 to 5, in which a resin forming the heat-sealable resin layer has a polyolefin backbone.

Item 7. The exterior material for electrical storage devices according to any one of items 1 to 6, in which the resin forming the heat-sealable resin layer contains polypropylene.

Item 8. The exterior material for electrical storage devices according to any one of items 1 to 7, in which an adhesive layer is provided between the barrier layer and the heat-sealable resin layer, and a resin forming the adhesive layer has a polyolefin backbone.

Item 9. The exterior material for electrical storage devices according to item 8, in which in the adhesive layer, a melting peak is observed in a range of 120° C. or higher and 170° C. or lower.

Item 10. The exterior material for electrical storage devices according to item 8 or 9, in which the resin forming the adhesive layer contains acid-modified polypropylene.

Item 11. The exterior material for electrical storage devices according to any one of items 1 to 10, in which a difference between the melting peak temperature and a softening point of the heat-sealable resin layer is 30° C. or less.

Item 12. A method for manufacturing an exterior material for electrical storage devices, the method including the step of laminating at least a base material layer, a barrier layer and a heat-sealable resin layer in this order to obtain a laminate, the heat-sealable resin layer having a molecular weight of 150,000 or more in terms of a peak value in a differential molecular weight distribution curve obtained by high-temperature gel permeation chromatography measurement.

Item 13. An electrical storage device in which an electrical storage device element including at least a positive electrode, a negative electrode and an electrolyte is housed in a packaging formed of the exterior material for electrical storage devices according to any one of items 1 to 11.

### DESCRIPTION OF REFERENCE SIGNS

1: Base material layer
2: Adhesive agent layer
3: Barrier layer
4: Heat-sealable resin layer
4a: Probe installation position
5: Adhesive layer
6: Surface coating layer
10: Exterior material for electrical storage devices

1. An exterior material for electrical storage devices comprising a laminate including at least a base material layer, a barrier layer and a heat-sealable resin layer in this order, wherein
the heat-sealable resin layer having a molecular weight of 150,000 or more in terms of a peak value in a differential molecular weight distribution curve obtained by high-temperature gel permeation chromatography measurement.

2. The exterior material for electrical storage devices according to claim 1, wherein a Martens hardness is 10.0 MPa or more as measured on the basis of an indentation method with a Vickers indenter pressed to a depth of 1 μm in a thickness direction from a surface of the exterior material for electrical storage devices on the heat-sealable resin layer side at a measurement temperature of 100° C.

3. An exterior material for electrical storage devices comprising a laminate including at least a base material layer, a barrier layer and a heat-sealable resin layer in this order, wherein
a Martens hardness is 10.0 MPa or more as measured on the basis of an indentation method with a Vickers indenter pressed to a depth of 1 μm in a thickness direction from a surface of the exterior material for electrical storage devices on the heat-sealable resin layer side at a measurement temperature of 100° C.

4. The exterior material for electrical storage devices according to claim 1, wherein a TL value calculated by dividing a concentration fraction of a molecular weight, at which the concentration fraction reaches a peak value, by a concentration fraction of a molecular weight lower by 120,000 than the molecular weight at which the concentration fraction reaches a peak value, in the differential molecular weight distribution curve with the molecular weight (logarithmic value) in the horizontal axis and the concentration fraction of the molecular weight in the vertical axis is 1.00 or more and 2.80 or less.

5. The exterior material for electrical storage devices according to claim 1, wherein a melting peak temperature of 130° C. or lower is observed in the heat-sealable resin layer.

6. The exterior material for electrical storage devices according to claim 1, wherein a resin forming the heat-sealable resin layer has a polyolefin backbone.

7. The exterior material for electrical storage devices according to claim 1, wherein the resin forming the first heat-sealable resin layer contains polypropylene.

8. The exterior material for electrical storage devices according to claim 1, wherein
an adhesive layer is provided between the barrier layer and the heat-sealable resin layer, and
a resin forming the adhesive layer has a polyolefin backbone.

9. The exterior material for electrical storage devices according to claim 8, wherein in the adhesive layer, a melting peak is observed in a range of 120° C. or higher and 170° C. or lower.

10. The exterior material for electrical storage devices according to claim 8, wherein the resin forming the adhesive layer contains acid-modified polypropylene.

11. The exterior material for electrical storage devices according to claim 1, wherein a difference between the melting peak temperature and a softening point of the heat-sealable resin layer is 30° C. or less.

12. A method for manufacturing an exterior material for electrical storage devices, the method comprising the step of laminating at least a base material layer, a barrier layer and a heat-sealable resin layer in this order to obtain a laminate, wherein
the heat-sealable resin layer having a molecular weight of 150,000 or more in terms of a peak value in a differential molecular weight distribution curve obtained by high-temperature gel permeation chromatography measurement.

13. An electrical storage device in which an electrical storage device element including at least a positive electrode, a negative electrode and an electrolyte is housed in a packaging formed of the exterior material for electrical storage devices according to claim 1.

14. The exterior material for electrical storage devices according to claim 1, wherein the base material layer comprises a laminate of a polyester film and a polyamide film, a laminate of a polyester film and a polyester film, or a laminate of a polyamide film and a polyamide film.

15. The exterior material for electrical storage devices according to claim 1, wherein the thickness of the laminate is 155 μm or less.

16. The exterior material for electrical storage devices according to claim 1, wherein the thickness of the laminate is more than 155 μm and 180 μm or less.

17. The exterior material for electrical storage devices according to claim 1, wherein the thickness of the laminate is more than 180 μm and 190 μm or less.

18. The exterior material for electrical storage devices according to claim 1, wherein the thickness of the base material layer is 35 μm or less.

19. The exterior material for electrical storage devices according to claim 1, wherein the thickness of the base material layer is more than 35 μm.

20. The exterior material for electrical storage devices according to claim 1, wherein the exterior material for electrical storage devices is colored.

21. The exterior material for electrical storage devices according to claim 1, wherein the laminate comprises an adhesive agent layer between the base material layer and the barrier layer, and
the adhesive agent layer comprises a colorant.

22. The exterior material for electrical storage devices according to claim 1, wherein the laminate comprises a colored layer between the base material layer and the barrier layer.

23. The exterior material for electrical storage devices according to claim 1, wherein the laminate comprises a surface coating layer on a surface of the base material layer on a side opposite to the barrier layer.

24. The exterior material for electrical storage devices according to claim 1, wherein the thickness of the barrier layer is 50 μm or less.

25. The exterior material for electrical storage devices according to claim 1, wherein the thickness of the barrier layer is more than 50 μm and 200 μm or less.

26. The exterior material for electrical storage devices according to claim 1, wherein the laminate comprises an adhesive layer between the barrier layer and the heat-sealable resin layer, and
the thickness of the adhesive layer is less than 10 μm.

27. The exterior material for electrical storage devices according to claim 1, wherein the laminate comprises an adhesive layer between the barrier layer and the heat-sealable resin layer, and
the thickness of the adhesive layer is 10 μm or more and less than 20 μm.

28. The exterior material for electrical storage devices according to claim 1, wherein the laminate comprises an adhesive layer between the barrier layer and the heat-sealable resin layer, and
the thickness of the adhesive layer is 20 μm or more and less than 30 μm.

29. The exterior material for electrical storage devices according to claim 1, wherein the laminate comprises an adhesive layer between the barrier layer and the heat-sealable resin layer, and
the thickness of the adhesive layer is 30 μm or more and less than 60 μm.

30. The method for manufacturing an exterior material for electrical storage devices according to claim 12,
wherein the laminate comprises an adhesive layer between the barrier layer and the heat-sealable resin layer, and
the adhesive layer and the heat-sealable layer are formed by a coextrusion lamination method, a tandem lamination method, a thermal lamination method, or a method in which an adhesive for forming the adhesive layer is applied on the barrier layer and the heat-sealable resin layer formed in a sheet shape in advance is laminated.

31. The method for manufacturing an exterior material for electrical storage devices according to claim 12,
wherein the laminate comprises an adhesive layer between the barrier layer and the heat-sealable resin layer, and
the adhesive layer and the heat-sealable layer are formed by a sandwich lamination method.

32. The method for manufacturing an exterior material for electrical storage devices according to claim 12,
wherein the laminate comprises an adhesive layer between the barrier layer and the heat-scalable resin layer, and
the heat-scalable resin layer is composed of two or more layers with the same resin component or different resin components.
